(19) United States
(12) Patent Application Publication
(10) Pub. No.: US 2026/0155945 A1
(43) Pub. Date: Jun. 4, 2026

(54) NON-UNIFORM PATTERNS FOR POSITIONING REFERENCE SIGNALS

(71) Applicant: QUALCOMM Incorporated, San Diego, CA (US)

(72) Inventors: Wei XI, Beijing (CN); Min HUANG, Beijing (CN); Chao WEI, Beijing (CN); Hao XU, Beijing (CN)

(21) Appl. No.: 19/125,255

(22) PCT Filed: Nov. 30, 2022
(86) PCT No.: PCT/CN2022/135333

§ 371 Date: Apr. 28, 2025

(51) Int. Cl. H04L 5/00; H04W 72/231

(52) U.S. Cl. CPC H04L 5/0094; H04W 72/231

(57) ABSTRACT

A network node may transmit a positioning reference signal (PRS) configuration that indicates a set of non-uniform patterns in a frequency domain for a set of PRSs. A user equipment (UE) may receive the PRS configuration that indicates the set of non-uniform patterns in the frequency domain for the set of PRSs. The network node may transmit the set of PRSs based on the PRS configuration. Each PRS of the set of PRSs may be associated with a corresponding non-uniform pattern of the set of non-uniform patterns in the frequency domain. The UE may receive the set of PRSs based on the PRS configuration. The UE may measure each PRS of the set of PRSs based on the corresponding non-uniform pattern of the set of non-uniform patterns in the frequency domain.

### TECHNICAL FIELD

The present disclosure relates generally to communication systems, and more particularly, to positioning wireless devices.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a user equipment (UE). The apparatus may receive a positioning reference signal (PRS) configuration that indicates a set of non-uniform patterns in a frequency domain for a set of PRSs. The apparatus may receive the set of PRSs based on the PRS configuration. Each PRS of the set of PRSs may be associated with a corresponding non-uniform pattern of the set of non-uniform patterns in the frequency domain. The apparatus may measure each PRS of the set of PRSs based on the corresponding non-uniform pattern of the set of non-uniform patterns in the frequency domain.

In an aspect of the disclosure, a method, a computer-readable medium, and an apparatus are provided. The apparatus may be a network node. The apparatus may transmit a PRS configuration that indicates a set of non-uniform patterns in a frequency domain for a set of PRSs. The apparatus may transmit the set of PRSs based on the PRS configuration. Each PRS of the set of PRSs may be associated with a corresponding non-uniform pattern of the set of non-uniform patterns in the frequency domain

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a connection flow diagram illustrating an example of a wireless system configured to use non-uniform patterns for positioning reference signals (PRSs).

FIG. 6 is a flowchart of a method of wireless communication.

FIG. 7 is a flowchart of a method of wireless communication.

FIG. 8 is a flowchart of a method of wireless communication.

FIG. 9 is a flowchart of a method of wireless communication.

FIG. 10 is a flowchart of a method of wireless communication.

FIG. 11 is a flowchart of a method of wireless communication.

FIG. 12 is a diagram illustrating an example of a hardware implementation for an example apparatus and/or network entity.

FIG. 13 is a diagram illustrating an example of a hardware implementation for an example network entity.

FIG. 14 is a diagram illustrating an example of a hardware implementation for an example network entity.

### DETAILED DESCRIPTION

A wireless system may be configured to perform positioning using positioning reference signals (PRSs) with a uniform pattern in a frequency domain. In other words, for a comb size

$${K}_{comb}^{PRS} ,$$

every

$${K}_{comb}^{PRS}$$

resource elements (REs) in a PRS resource set may be allocated for the PRS. While uniform PRS patterns may enable high-resolution positioning and timing precision, uniform PRS patterns suffer from large overhead, as many resources are allocated for the PRS. In some aspects, a wireless system may configure a set of PRSs to have a sparse, or a non-uniform, pattern, which may reduce the overhead of the set of PRSs while maintaining a high-resolution positioning and timing precision.

A network node may transmit a PRS configuration that indicates a set of non-uniform patterns in a frequency domain for a set of PRSs. A user equipment may receive the PRS configuration that indicates the set of non-uniform patterns in the frequency domain for the set of PRSs. The network node may transmit the set of PRSs based on the PRS configuration. Each PRS of the set of PRSs may be associated with a corresponding non-uniform pattern of the set of non-uniform patterns in the frequency domain. The UE may receive the set of PRSs based on the PRS configuration. The UE may measure each PRS of the set of PRSs based on the corresponding non-uniform pattern of the set of non-uniform patterns in the frequency domain.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media may include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

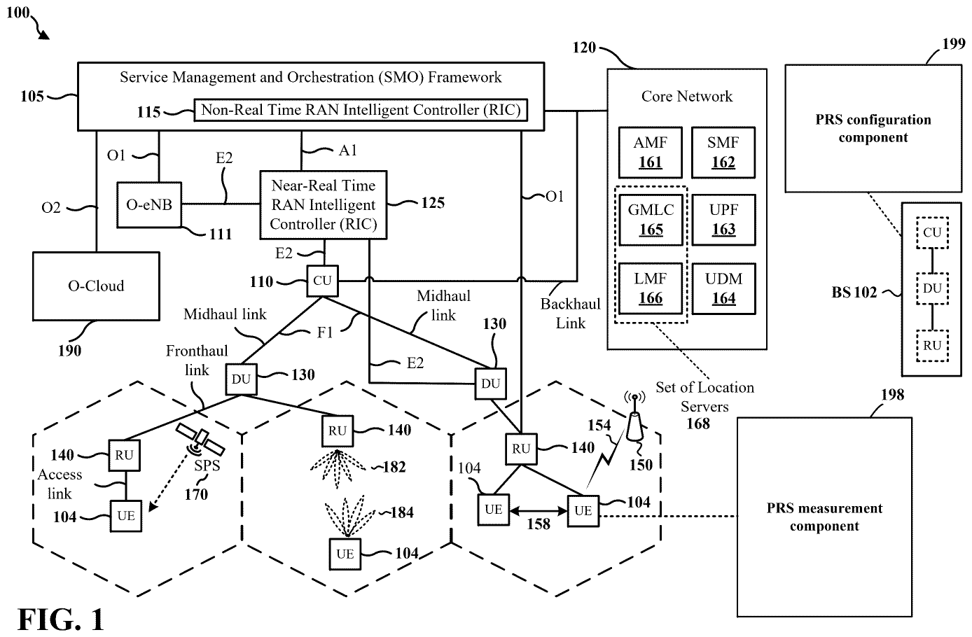

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmission reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a PRS measurement component 198 that may be configured to receive a PRS configuration that indicates a set of non-uniform patterns in a frequency domain for a set of PRSs. The PRS measurement component 198 may receive the set of PRSs based on the PRS configuration. Each PRS of the set of PRSs may be associated with a corresponding non-uniform pattern of the set of non-uniform patterns in the frequency domain. The PRS measurement component 198 may measure each PRS of the set of PRSs based on the corresponding non-uniform pattern of the set of non-uniform patterns in the frequency domain. In certain aspects, the base station 102 may have a PRS configuration component 199 that may be configured to transmit a PRS configuration that indicates a set of non-uniform patterns in a frequency domain for a set of PRSs. The PRS configuration component 199 may transmit the set of PRSs based on the PRS configuration. Each PRS of the set of PRSs may be associated with a corresponding non-uniform pattern of the set of non-uniform patterns in the frequency domain. Although the following description may be focused on sparse patterns, the concepts described herein may be applicable to any non-uniform pattern in a frequency domain for a set of PRSs in the downlink direction, or a set of SRSs in the uplink direction. Although the following description may be focused on 5G NR, the concepts described herein may be applicable to other similar areas, such as LTE, LTE-A, CDMA, GSM, and other wireless technologies.

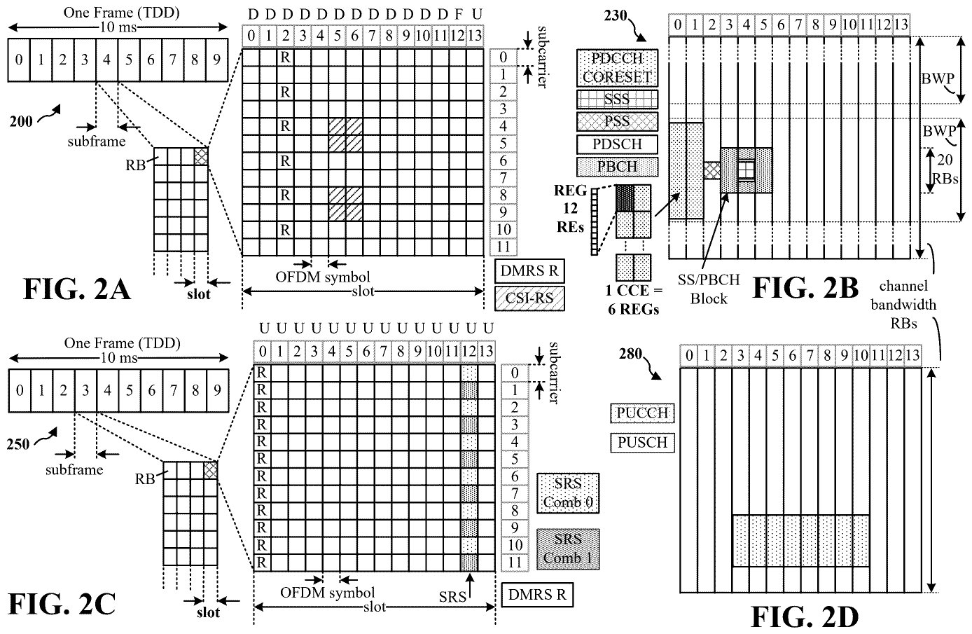

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

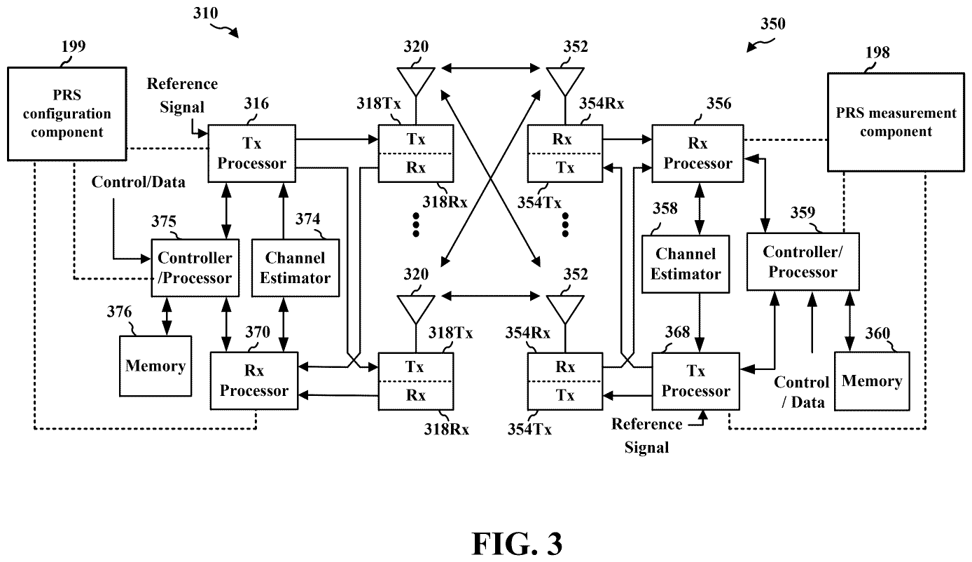

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (Tx) processor 316 and the receive (Rx) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The Tx processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (Rx) processor 356. The Tx processor 368 and the Rx processor 356 implement layer 1 functionality associated with various signal processing functions. The Rx processor 356 may perform spatial processing on the information to recover any spatial streams destined for the UE 350. If multiple spatial streams are destined for the UE 350, they may be combined by the Rx processor 356 into a single OFDM symbol stream. The Rx processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the Tx processor 368 to select the appropriate coding and modulation schemes, and to facilitate spatial processing. The spatial streams generated by the Tx processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a Rx processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the Tx processor 368, the Rx processor 356, and the controller/processor 359 may be configured to perform aspects in connection with the PRS measurement component 198 of FIG. 1.

At least one of the Tx processor 316, the Rx processor 370, and the controller/processor 375 may be configured to perform aspects in connection with the PRS configuration component 199 of FIG. 1.

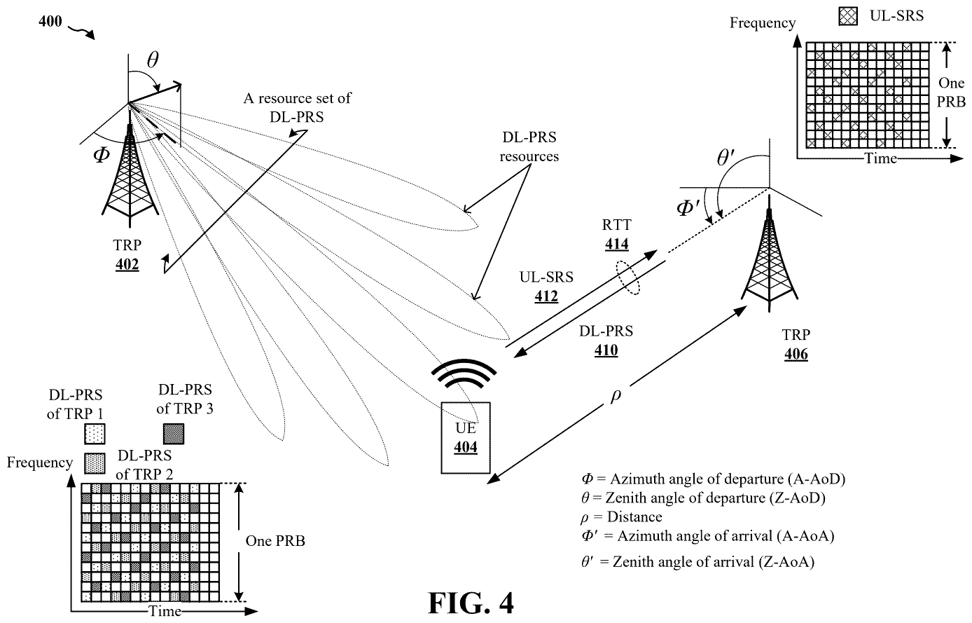

FIG. 4 is a diagram 400 illustrating an example of a UE positioning based on reference signal measurements. The UE 404 may transmit UL-SRS 412 at time T_{SRS_Tx} and receive DL positioning reference signals (PRS) (DL-PRS) 410 at time T_{PRS_Rx}. The TRP 406 may receive the UL-SRS 412 at time T_{SRS_Rx} and transmit the DL-PRS 410 at time T_{PRS_Tx}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_Rx}−T_{PRS_Tx}|−|T_{SRS_Tx}−T_{PRS_Rx}|. Accordingly, multi-RTT positioning may make use of the UE Rx-Tx time difference measurements (i.e., |T_{SRS_Tx}−T_{PRS_Rx}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_Rx}−T_{PRS_Tx}|) and UL-SRS-RSRP at multiple TRPs 402, 406 of uplink signals transmitted from UE 404. The UE 404 measures the UE Rx-Tx time difference measurements (and DL-PRS-RSRP of the received signals) using assistance data received from the positioning server, and the TRPs 402, 406 measure the gNB Rx-Tx time difference measurements (and UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and DL-PRS-RSRP) of downlink signals received from multiple TRPs 402, 406 at the UE 404. The UE 404 measures the DL RSTD (and DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and UL-SRS-RSRP) at multiple TRPs 402, 406 of uplink signals transmitted from UE 404. The TRPs 402, 406 measure the UL-RTOA (and UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. In some aspects, the UE may measure a direction or an angle of a CSI-RS as an alternative to a PRS or in addition to a PRS.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Positioning precision may be determined by the time-domain resolution of the PRS. If two wireless devices have a multipath channel link, the time for the PRS may be determined based on the timing of the first path of the multipath channel link. The timing of the first path may be calculated based on an inverse fast Fourier transform (IFFT) estimation or a multiple signal classification (MUSIC) spectrum estimation. In some aspects, the PRS may be configured to have a uniform pattern defined by a set of PRS parameters. The PRS parameters may include a number of PRS symbols L_{PRS}, which may define the number of consecutive OFDM symbols in a slot that are allocated for each PRS resource in a PRS resource set. The PRS parameters may include a comb size

$${K}_{comb}^{PRS} ,$$

which may define the RE density of PRS resources in a PRS resource set. In one aspect, a PRS having a uniform pattern defined by a number of PRS symbols L_{PRS}=2 and comb size

$${K}_{comb}^{PRS} = 2$$

may have a PRS resource with PRS RE evenly spaced across the frequency with an offset of 2 between each PRS RE (every 2^{nd} RE in the PRB is allocated for the PRS) spanning 2 symbols wide. Each symbol may be orthogonal with respect to one another. In other words, the symbols may be organized in a staggered pattern. In another aspect, a PRS having a uniform pattern defined by a number of PRS symbols L_{PRS}=6 and comb size

$${K}_{comb}^{PRS} = 6$$

may have a PRS resource with PRS RE evenly spaced across the frequency with an offset of 6 between each PRS RE (every 6th RE in the PRB is allocated for the PRS) spanning 6 symbols wide. Each symbol may be orthogonal with respect to one another (i.e., staggered pattern).

PRS that are configured with a uniform pattern may have its time-domain resolution based on the bandwidth of the PRS. An unambiguous observable range of a PRS configured with a uniform pattern may be based on the PRS density in the frequency domain. For example, the observable range of a uniform pattern PRS may depend on the comb value

$${K}_{comb}^{PRS} .$$

However, PRS configured with a uniform pattern may have a large overhead, as the entire spectrum of the PRS bandwidth has regularly spaced PRS REs. A PRS that is configured with a sparse, or a non-uniform, pattern may maintain the precision of a PRS configured with a uniform pattern, but may reduce the overhead used by the PRS REs. A PRS may be configured using a sparse or non-uniform pattern in frequency domain to achieve high timing and positioning resolution in difference co-array domain and Khatri-Rao subspace with a reduced number of PRS REs. A non-uniform pattern may include a pattern that has a first portion having a first uniform pattern and a second portion having a second uniform pattern, where the first uniform pattern and the second uniform pattern do not share the same uniform spacing. For example, the first portion may have a uniform spacing of 3 REs between PRS REs and the second portion may have a uniform spacing of 8 REs between PRS REs.

In one aspect, a network node may transmit a PRS configuration that indicates a set of non-uniform patterns in a frequency domain for a set of PRSs. A user equipment may receive the PRS configuration that indicates the set of non-uniform patterns in the frequency domain for the set of PRSs. The network node may transmit the set of PRSs based on the PRS configuration. Each PRS of the set of PRSs may be associated with a corresponding non-uniform pattern of the set of non-uniform patterns in the frequency domain. The UE may receive the set of PRSs based on the PRS configuration. The UE may measure each PRS of the set of PRSs based on the corresponding non-uniform pattern of the set of non-uniform patterns in the frequency domain.

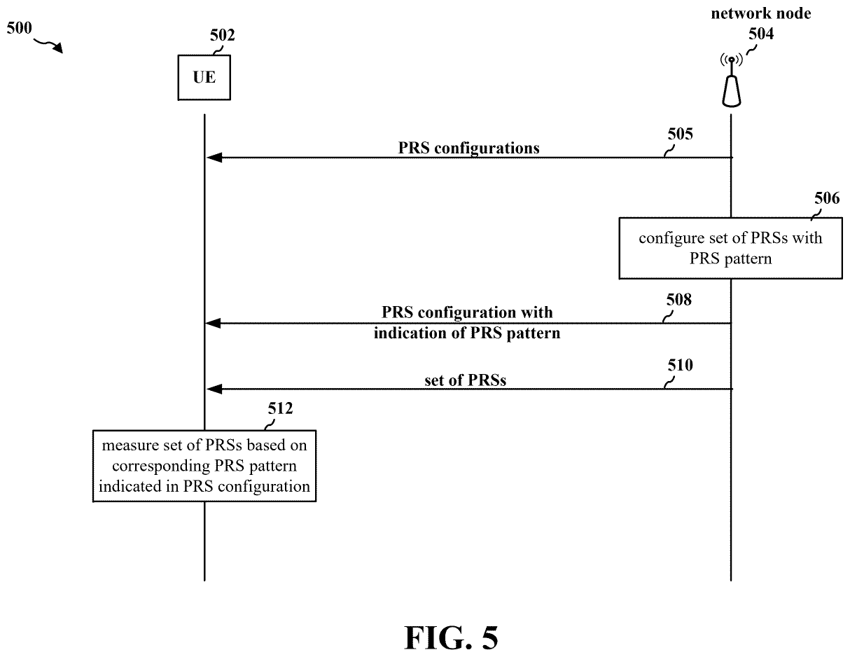

FIG. 5 is a connection flow diagram 500 illustrating an example of a wireless system that configures PRS patterns for a set of PRSs, and measures the set of PRSs based on the configured PRS pattern.

At 506, the network node 504 may configure a set of PRSs with a PRS pattern. The PRS pattern may be any suitable PRS pattern, for example a uniform pattern or a sparse (non-uniform) pattern. A non-uniform PRS pattern may be based on a sparse pattern configured to achieve high timing and positioning resolution with a reduced number of PRS REs. A non-uniform pattern, or a sparse pattern, may be any pattern that does not have a regular, consistent spacing throughout the PRS resource.

In one aspect the network node 504 may configure a set of PRSs using a nested pattern. A nested pattern may be a type of sparse pattern, or a type of non-uniform pattern. The nested pattern may represent subcarrier indices of the set of PRSs. The nested pattern may include a union of at least two base sequences. A base sequence may be an array of element indices that indicates spaces between REs of a PRS (e.g., subcarrier indices). For example, the nested pattern S may be based on a union of a first base sequence, S₁ and a second base sequence, S₂. In other words, S=S₁∪S₂. Each base sequence may be based on a length, calculated based on the total length N of the configured PRS. If the nested pattern S is based on a union of a first base sequence S₁ and a second base sequence S₂, each base sequence S₁ and S₂ may be based on a length N₁ and N₂, respectively, where N=N₁+N₂. The nested pattern S may be referred to as an array that is a union of two subarrays S₁ and S₂. In one aspect, if N is even, then

$${N}_{1} = {N}_{2} = \frac{N}{2} .$$

In another aspect, if N is odd, then

$${N}_{1} = \frac{N - 1}{2} , {N}_{2} = \frac{N + 1}{2} .$$

Each base sequence may have a fixed step-size between elements of the base sequence, but the fixed step-size of each base sequence may be different from one another. For example, if

$${N}_{1} = {N}_{2} = \frac{N}{2} or {N}_{1} = \frac{N - 1}{2} and {N}_{2} = \frac{N + 1}{2} ,$$

then S₁ may be defined as S₁={0, 1, . . . , N₁−1} and S₂ may be defined as S₂={N₁+(N₁+1)i|i=0, 1, . . . , N₂−1.}. In other words, the fixed step-size between elements of S₁ may be 1, and the fixed step-size between elements of S₂ may be (N₁+1).

The network node 504 may generate the nested pattern based on at least one of a length of PRS sequence, a set of base sequences (e.g., b₁ and b₂), a scaling factor β, a PRB offset K_{PRB}, a number of subcarriers in each PRB

$${N}_{subc}^{PRB} ,$$

or a subcarrier offset K_{subc}. In one aspect, the network node 504 may generate two base sequences b₁ and b₂ based on a length of PRS sequence N. b₁ may be defined as b₁={0, 1, 2, . . . , N₁−1} where

$${N}_{1} = ⌊ \frac{N}{2} ⌋ . {b}_{2}$$

may be defined as b₂={N₁, 2N₁+1, 3N₁+2, . . . , (N₁+1) N₂−1} where N₂=N−N₁. The network node 504 may combine the two base sequences b₁ and b₂ as a union of the base sequences, where b=b₁∪b₂={0, 1, 2, . . . , N₁, 2N₁+1, 3N₁+2, . . . , (N₁+1) N₂−1}. The network node 504 may scale the resulting base sequence with a scaling factor β, such that the scaled base sequence may be defined as βb. The network node 504 may add the product of the PRB offset K_{PRB} and the number of subcarriers in each PRB

$${N}_{subc}^{PRB}$$

in addition to adding the subcarrier offset K_{subc}, such that

$$S = β b + {N}_{subc}^{PRB} {K}_{PRB} + {K}_{subc} .$$

In other words, the network node 504 may generate a set of subcarrier indices S for a nested PRS pattern such that

$$S = β ( \{ 0 , 1 , 2 , … , {N}_{1} - 1 \} ⋃ \{ {N}_{1} , 2 {N}_{1} + 1 , 3 {N}_{1} + 2 , … , ( {N}_{1} + 1 ) {N}_{2} - 1 \} ) + {N}_{subc}^{PRB} {K}_{PRB} + {K}_{subc} , where {N}_{1} = ⌊ \frac{N}{2} ⌋ and {N}_{2} = N - {N}_{1} .$$

In some aspects, the number of subcarriers in each PRB

$${N}_{subc}^{PRB}$$

may be 12 in a NR wireless system.

For example, the network node 504 may generate a set of subcarrier indices S for a nested PRS pattern based on a length of PRS sequence N=10, a scaling factor β=4, a PRB offset K_{PRB}=0, and a subcarrier offset K_{subc}=1. For N=10, N₁=N₂=5, such may be used to generate the base sequences b₁={0, 1, 2, 3, 4} and b₂={5, 11, 17, 23, 29}. The combination of the base sequences may be represented by b=b₁∪b₂={0, 1, 2, 3, 4, 5, 11, 17, 23, 29}. Scaling the combination of the base sequences using the scaling factor β=4 may result in βb={0, 4, 8, 12, 16, 20, 44, 68, 92, 116}. Adding the product of the PRB offset K_{PRB}=0 and the number of subcarriers in each PRB

$${N}_{subc}^{PRB} = 12$$

in addition to adding the subcarrier offset K_{subc}=1 may result in S={1, 5, 9, 13, 17, 21, 45, 69, 93, 117}. Such a nested RS pattern may be used as the subcarrier indices for a nested PRS pattern for the set of PRSs by the network node 504.

In one aspect the network node 504 may configure a set of PRSs using a co-prime pattern. A co-prime array may be a type of sparse pattern, or a type of non-uniform pattern. The co-prime pattern may represent subcarrier indices of the set of PRSs. The co-prime pattern may include a union of at least two base sequences. For example, the co-prime pattern S may be based on a union of a first base sequence, S₁ and a second base sequence, S₂. In other words, S=S₁∪S₂. The co-prime pattern S may be referred to as an array that is a union of two subarrays S₁ and S₂. Each base sequence may be based on the total length N of the configured PRS. If the co-prime pattern S is based on a union of a first base sequence S₁ and a second base sequence S₂, each base sequence S₁ and S₂ may be based on a set of co-prime integers. The set of co-prime integers may be described as P and Q where P<Q and N=2P+Q−1. Each base sequence may have a fixed step-size between elements of the base sequence, but the fixed step-size of each base sequence may be different from one another. For example, S₁ may be defined as S₁={qP|q=0, 1, . . . , Q−1} and S₂ may be defined as S₂={pQ|p=0, 1, . . . , 2P−1}. In other words, the fixed step-size between elements of S₁ may be P, and the fixed step-size between elements of S₂ may be Q, where P<Q.

The network node 504 may generate the co-prime array based on at least one of a length of PRS sequence, a set of base sequences (e.g., b₁ and b₂), a scaling factor β, a PRB offset K_{PRB}, a number of subcarriers in each PRB

$${N}_{subc}^{PRB} ,$$

or a subcarrier offset K_{subc}. In one aspect, the network node 504 may generate two base sequences b₁ and b₂ based on a length of PRS sequence N. b₁ may be defined as b₁={qP|q=0, 1, . . . , Q−1} where N=2P+Q−1 and P<Q. b₂ may be defined as b₂={pQ|p=0, 1, . . . , 2P−1} where N=2P+Q−1 and P<Q. The network node 504 may combine the two base sequences b₁ and b₂ as a union of the base sequences, where b=b₁∪b₂={0, P, 2P, . . . , Q−1, Q, 2Q, . . . , 2P−1}. The network node 504 may scale the resulting base sequence with a scaling factor β, such that the scaled base sequence may be defined as βb. The network node 504 may add the product of the PRB offset K_{PRB} and the number of subcarriers in each PRD

$${N}_{subc}^{PRB}$$

in addition to adding the subcarrier offset K_{subc}, such that

$$S = β b + {N}_{subc}^{PRB} {K}_{PRB} + {K}_{subc} .$$

In other words, the network node 504 may generate a set of subcarrier indices S for a co-prime PRS pattern such that

$$S = β ( \{ qP \vert q = 0 , 1 , , Q - 1 \} ⋃ \{ pQ \vert p = 0 , 1 , , 2 P - 1 \} ) + {N}_{subc}^{PRB} {K}_{PRB} + {K}_{subc} , where N = 2 P + Q - 1 and P < Q .$$

In some aspects, the number of subcarriers in each PRB

$${N}_{subc}^{PRB}$$

may be 12 in a NR wireless system.

For example, the network node 504 may generate a set of subcarrier indices S for a co-prime PRS pattern based on a length of PRS sequence N=6, a scaling factor β=5, a PRB offset K_{PRB}=0, and a subcarrier offset K_{subc}=2. For N=6, P=2 and Q=3. The co-prime integers P=2 and =3 may be used to generate the base sequences b₁={0, 2, 4} and b₂={0, 3, 6, 9}. The combination of the base sequences may be represented by b=b₁∪b₂={0, 2, 3, 4, 6, 9}. Scaling the combination of the base sequences using the scaling factor β=5 may result in βb={0, 10, 15, 20, 30, 45}. Adding the product of the PRB offset K_{PRB}=0 and the number of subcarriers in each PRB

$${N}_{subc}^{PRB} = 12$$

in addition to adding the subcarrier offset K_{subc}=2 may result in S={2, 12, 17, 22, 32, 47}. Such a co-prime RS pattern may be used as the subcarrier indices for a co-prime PRS pattern for the set of PRSs by the network node 504.

In one aspect the network node 504 may configure a set of PRSs using a uniform pattern. The network node 504 may configure the uniform set for PRSs based on a set of PRS parameters. The PRS parameters may include a number of PRS symbols L_{PRS}, which may define the number of consecutive OFDM symbols in a slot that are allocated for each PRS resource in a PRS resource set. The PRS parameters may include a comb size

$${K}_{comb}^{PRS} ,$$

which may define the RE density of PRS resources in a PRS resource set. In one aspect, a PRS having a uniform pattern defined by a number of PRS symbols L_{PRS}=2 and comb size

$${K}_{comb}^{PRS} = 2$$

may have a PRS resource with PRS RE evenly spaced across the frequency with an offset of 2 between each PRS RE (every 2^{nd} RE in the PRB is allocated for the PRS) spanning 2 symbols wide. Each symbol may be orthogonal with respect to one another, a.k.a. staggered pattern. In another aspect, a PRS having a uniform pattern defined by a number of PRS symbols L_{PRS}=6 and comb size

$${K}_{comb}^{PRS} = 6$$

may have a PRS resource with PRS RE evenly spaced across the frequency with an offset of 6 between each PRS RE (every 6th RE in the PRB is allocated for the PRS) spanning 6 symbols wide. Each symbol may be orthogonal with respect to one another, a.k.a. staggered pattern.

The network node 504 may transmit the PRS configuration 508 with an indication of the configured PRS pattern to the UE 502. The UE 502 may receive the PRS configuration 508 with an indication of the configured PRS pattern from the network node 504. The PRS configuration 508 may include one or more PRS parameters of the configured set of PRSs. The PRS parameters may include a type of PRS pattern, a scaling factor β, a PRB offset K_{PRB}, a subcarrier offset K_{subc}, a symbol offset, a slot offset, a frame index, a periodicity, a length of PRS sequence N, a co-prime integer P, or a co-prime integer Q. In one aspect, the PRS configuration 508 may indicate that type of PRS pattern of the configured set of PRSs have a uniform pattern or a non-uniform pattern (e.g., a nested pattern or a co-prime pattern). In some aspects the PRS configuration 508 may directly indicate that the configured set of PRSs have a uniform pattern, a nested pattern, or a co-prime pattern. In one aspect, at least one of the scaling factor β, the PRB offset K_{PRB}, or the subcarrier offset K_{subc} may indicate frequency domain resources for the configured set of PRSs. In one aspect, at least one of the symbol offset, the slot offset, the frame index, or the periodicity may indicate time domain resources for the configured set of PRSs. In one aspect, the length of PRS sequence N may represent a special parameter for a nested PRS pattern. In one aspect, at least one of the co-prime integer P or the co-prime integer Q may represent a special parameter for a co-prime PRS pattern. The network node 504 may transmit the PRS configuration 508 as DCI, a MAC-CE, or an RRC configuration.

In some aspects, the one or more PRS parameters of the PRS configuration 508 may include common parameters for all of the PRS resources of the configured set of PRSs (e.g., a uniform pattern or a sparse pattern, a nested pattern or a coprime pattern). In some aspects, the one or more PRS parameters of the PRS configuration 508 may include a dedicated parameter for each PRS resource of the configured set of PRSs (e.g., a subcarrier offset K_{subc} value for each symbol for a staggered pattern).

In some aspects, the network node 504 may initially transmit a set of PRS configurations 505 to the UE 502. Each of the set of PRS configurations 505 may include one or more PRS parameters. The set of PRS configurations 505 may have identical, or different, sparse PRS patterns. The set of PRS configurations 505 may be transmitted as an RRC configuration. The network node 504 may then transmit the PRS configuration 508 as a selection of one of the set of PRS configurations 505. The network node 504 may transmit the PRS configuration 508 as DCI or a MAC-CE that selects one of the set of PRS configurations 505 transmitted as an RRC configuration to the UE 502.

The network node 504 may transmit the set of PRSs 510 to the UE 502. The set of PRSs may be transmitted using the PRS pattern indicated by the PRS configuration 508. The UE 502 may receive the set of PRSs 510. At 512, the UE 502 may measure the set of PRSs 510 based on the corresponding PRS pattern indicated in the PRS configuration 508. If the PRS pattern is a sparse PRS pattern (e.g., a nested PRS pattern or a co-prime PRS pattern), the wireless system may reduce the overhead used by the set of PRSs as compared with PRSs configured with uniform PRS patterns.

While the connection flow diagram 500 may focus on a method of using non-uniform, or sparse, patterns for a set of PRSs 510 transmitted from the network node 504 to the UE 502, such a method may be used for using non-uniform, or sparse, patterns for a set of SRSs transmitted from the UE 502 to the network node 504. In other words, the network node 504 may transmit a set of SRS configurations to the UE 502 that indicate a set of non-uniform patterns in a frequency domain for a set of SRSs, and the UE 502 may transmit the set of SRSs based on the set of SRS configurations to the network node 504. Such a configuration may also reduce the overhead of the set of SRSs while maintaining a performance metrics.

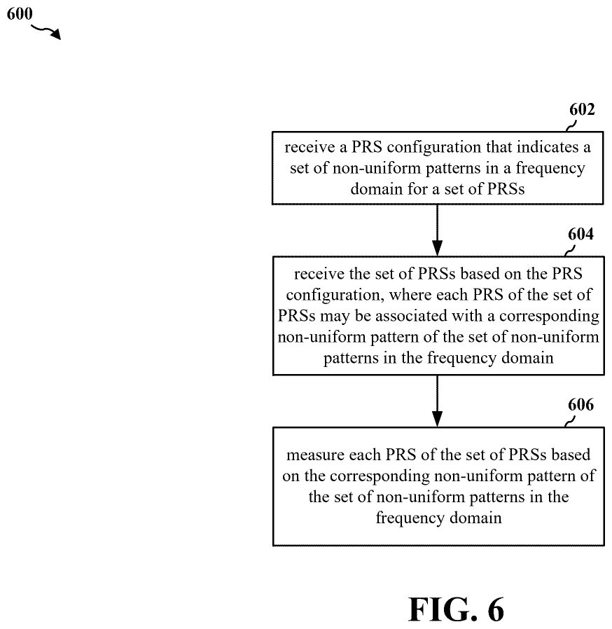

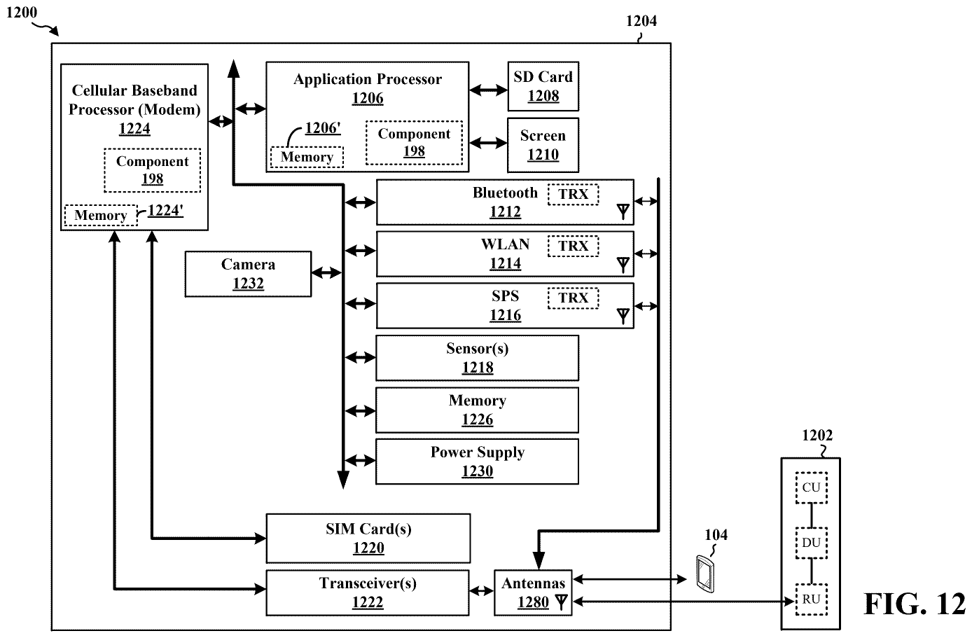

FIG. 6 is a flowchart 600 of a method of wireless communication. The method may be performed by a UE (e.g., the UE 104, the UE 350, the UE 404, the UE 502; the apparatus 1204). At 602, the UE may receive a PRS configuration that indicates a set of non-uniform patterns in a frequency domain for a set of PRSs. For example, 602 may be performed by the UE 502 in FIG. 5, which may receive the PRS configuration 508 from the network node 504. The PRS configuration 508 may indicate a set of non-uniform patterns, such as a nested pattern or a co-prime pattern, in a frequency domain for the set of PRSs 510. Moreover, 602 may be performed by the component 198 in FIG. 12.

At 604, the UE may receive the set of PRSs based on the PRS configuration. Each PRS of the set of PRSs may be associated with a corresponding non-uniform pattern of the set of non-uniform patterns in the frequency domain. For example, 604 may be performed by the UE 502 in FIG. 5, which may receive the set of PRSs 510 based on the PRS configuration 508. Each PRS of the set of PRSs 510 may be associated with a corresponding non-uniform pattern of the set of non-uniform patterns in the frequency domain. Moreover, 604 may be performed by the component 198 in FIG. 12.

At 606, the UE may measure each PRS of the set of PRSs based on the corresponding non-uniform pattern of the set of non-uniform patterns in the frequency domain. For example, 606 may be performed by the UE 502 in FIG. 5, which may, at 512, measure each PRS of the set of PRSs based on the corresponding non-uniform pattern of the set of non-uniform patterns in the frequency domain. Moreover, 606 may be performed by the component 198 in FIG. 12.

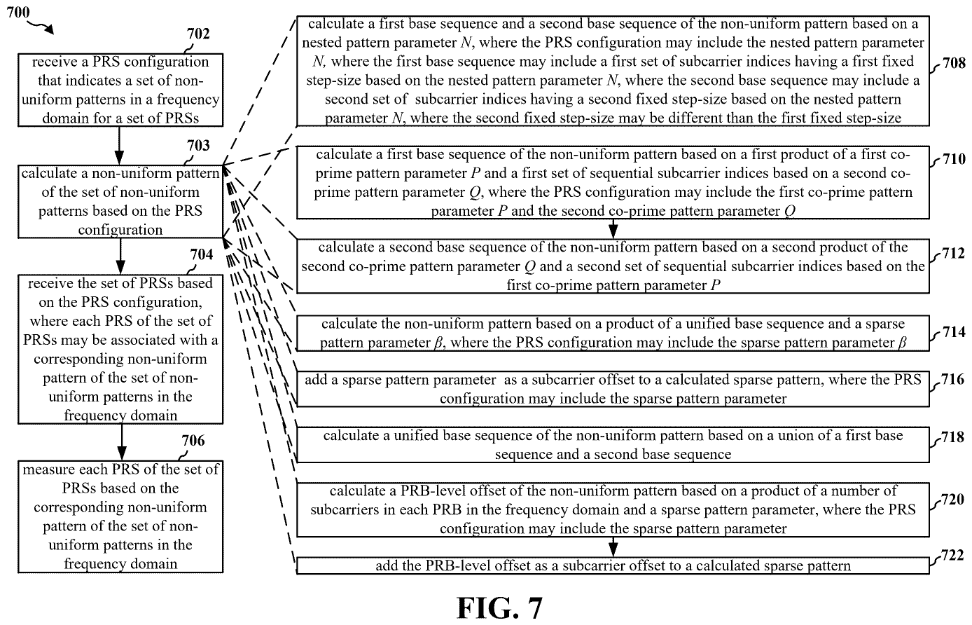

FIG. 7 is a flowchart 700 of a method of wireless communication. The method may be performed by a UE (e.g., the UE 104, the UE 350, the UE 404, the UE 502; the apparatus 1204). At 702, the UE may receive a PRS configuration that indicates a set of non-uniform patterns in a frequency domain for a set of PRSs. For example, 702 may be performed by the UE 502 in FIG. 5, which may receive the PRS configuration 508 from the network node 504. The PRS configuration 508 may indicate a set of non-uniform patterns, such as a nested pattern or a co-prime pattern, in a frequency domain for the set of PRSs 510. Moreover, 702 may be performed by the component 198 in FIG. 12.

At 703, the UE may calculate a non-uniform pattern of the set of non-uniform patterns based on the PRS configuration. For example, 703 may be performed by the UE 502 in FIG. 5, which may calculate a non-uniform pattern of the set of non-uniform patterns based on the PRS configuration. Moreover, 703 may be performed by the component 198 in FIG. 12.

At 704, the UE may receive the set of PRSs based on the PRS configuration. Each PRS of the set of PRSs may be associated with a corresponding non-uniform pattern of the set of non-uniform patterns in the frequency domain. For example, 704 may be performed by the UE 502 in FIG. 5, which may receive the set of PRSs 510 based on the PRS configuration 508. Each PRS of the set of PRSs 510 may be associated with a corresponding non-uniform pattern of the set of non-uniform patterns in the frequency domain. Moreover, 704 may be performed by the component 198 in FIG. 12.

At 706, the UE may measure each PRS of the set of PRSs based on the corresponding non-uniform pattern of the set of non-uniform patterns in the frequency domain. For example, 706 may be performed by the UE 502 in FIG. 5, which may, at 512, measure each PRS of the set of PRSs based on the corresponding non-uniform pattern of the set of non-uniform patterns in the frequency domain. Moreover, 706 may be performed by the component 198 in FIG. 12.

At 708, the UE may calculate a first base sequence and a second base sequence of the non-uniform pattern based on a nested pattern parameter N. The PRS configuration may include the nested pattern parameter N. The first base sequence may include a first set of subcarrier indices having a first fixed step-size based on the nested pattern parameter N. The second base sequence may include a second set of subcarrier indices having a second fixed step-size based on the nested pattern parameter N. The second fixed step-size may be different than the first fixed step-size. For example, 708 may be performed by the UE 502 in FIG. 5, which may calculate a first base sequence and a second base sequence of the non-uniform pattern based on a nested pattern parameter N. The PRS configuration may include the nested pattern parameter N. The first base sequence may include a first set of subcarrier indices having a first fixed step-size based on the nested pattern parameter N. The second base sequence may include a second set of subcarrier indices having a second fixed step-size based on the nested pattern parameter N. The second fixed step-size may be different than the first fixed step-size. Moreover, 708 may be performed by the component 198 in FIG. 12.

At 710, the UE may calculate a first base sequence of the non-uniform pattern based on a first product of a first co-prime pattern parameter P and a first set of sequential subcarrier indices based on a second co-prime pattern parameter Q. The PRS configuration may include the first co-prime pattern parameter P and the second co-prime pattern parameter Q. For example, 710 may be performed by the UE 502 in FIG. 5, which may calculate a first base sequence of the non-uniform pattern based on a first product of a first co-prime pattern parameter P and a first set of sequential subcarrier indices based on a second co-prime pattern parameter Q. The PRS configuration may include the first co-prime pattern parameter P and the second co-prime pattern parameter Q. Moreover, 710 may be performed by the component 198 in FIG. 12.

At 712, the UE may calculate a second base sequence of the non-uniform pattern based on a second product of the second co-prime pattern parameter Q and a second set of sequential subcarrier indices based on the first co-prime pattern parameter P. For example, 712 may be performed by the UE 502 in FIG. 5, which may calculate a second base sequence of the non-uniform pattern based on a second product of the second co-prime pattern parameter Q and a second set of sequential subcarrier indices based on the first co-prime pattern parameter P. Moreover, 712 may be performed by the component 198 in FIG. 12.

At 714, the UE may calculate the non-uniform pattern based on a product of a combined base sequence and a sparse pattern parameter β. The PRS configuration may include the sparse pattern parameter β. For example, 714 may be performed by the UE 502 in FIG. 5, which may calculate the non-uniform pattern based on a product of a combined base sequence and a sparse pattern parameter β. The PRS configuration may include the sparse pattern parameter β. Moreover, 714 may be performed by the component 198 in FIG. 12.

At 716, the UE may add a sparse pattern parameter as a subcarrier offset to a calculated sparse pattern. The PRS configuration may include the sparse pattern parameter. For example, 716 may be performed by the UE 502 in FIG. 5, which may add a sparse pattern parameter as a subcarrier offset to a calculated sparse pattern. The PRS configuration may include the sparse pattern parameter. Moreover, 716 may be performed by the component 198 in FIG. 12.

At 718, the UE may calculate a combined base sequence of the non-uniform pattern based on a union of a first base sequence and a second base sequence. For example, 718 may be performed by the UE 502 in FIG. 5, which may calculate a combined base sequence of the non-uniform pattern based on a union of a first base sequence and a second base sequence. Moreover, 718 may be performed by the component 198 in FIG. 12.

At 720, the UE may calculate a PRB-level offset of the non-uniform pattern based on a product of a number of subcarriers in each PRB in the frequency domain and a sparse pattern parameter. The PRS configuration may include the sparse pattern parameter. For example, 720 may be performed by the UE 502 in FIG. 5, which may calculate a PRB-level offset of the non-uniform pattern based on a product of a number of subcarriers in each PRB in the frequency domain and a sparse pattern parameter. The PRS configuration may include the sparse pattern parameter. Moreover, 720 may be performed by the component 198 in FIG. 12.

At 722, the UE may add the PRB-level offset as a subcarrier offset to a calculated sparse pattern. For example, 722 may be performed by the UE 502 in FIG. 5, which may add the PRB-level offset as a subcarrier offset to a calculated sparse pattern. Moreover, 722 may be performed by the component 198 in FIG. 12.

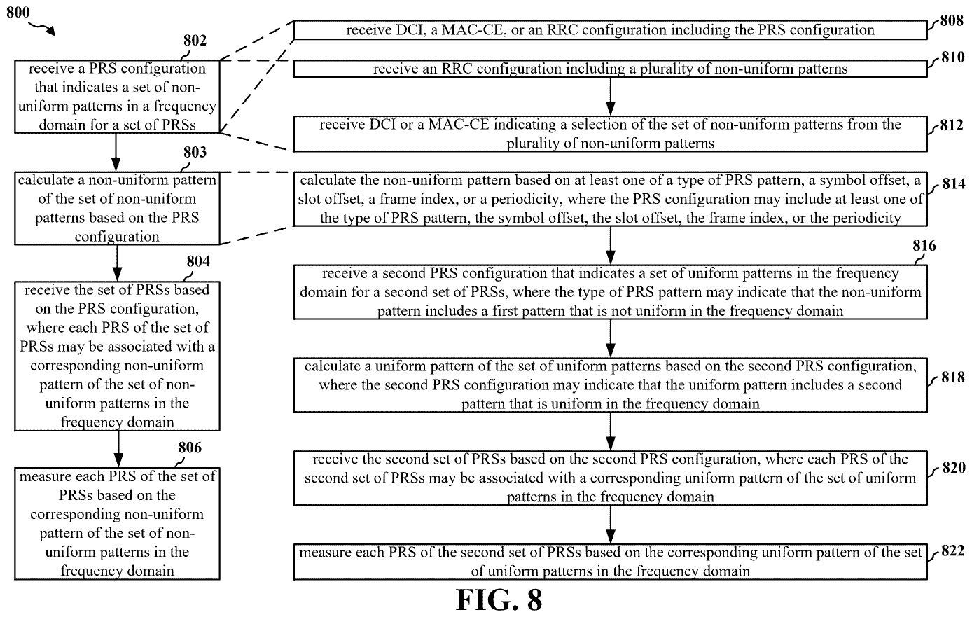

FIG. 8 is a flowchart 800 of a method of wireless communication. The method may be performed by a UE (e.g., the UE 104, the UE 350, the UE 404, the UE 502; the apparatus 1204). At 802, the UE may receive a PRS configuration that indicates a set of non-uniform patterns in a frequency domain for a set of PRSs. For example, 802 may be performed by the UE 502 in FIG. 5, which may receive the PRS configuration 508 from the network node 504. The PRS configuration 508 may indicate a set of non-uniform patterns, such as a nested pattern or a co-prime pattern, in a frequency domain for the set of PRSs 510. Moreover, 802 may be performed by the component 198 in FIG. 12.

At 803, the UE may calculate a non-uniform pattern of the set of non-uniform patterns based on the PRS configuration. For example, 803 may be performed by the UE 502 in FIG. 5, which may calculate a non-uniform pattern of the set of non-uniform patterns based on the PRS configuration. Moreover, 803 may be performed by the component 198 in FIG. 12.

At 804, the UE may receive the set of PRSs based on the PRS configuration. Each PRS of the set of PRSs may be associated with a corresponding non-uniform pattern of the set of non-uniform patterns in the frequency domain. For example, 804 may be performed by the UE 502 in FIG. 5, which may receive the set of PRSs 510 based on the PRS configuration 508. Each PRS of the set of PRSs 510 may be associated with a corresponding non-uniform pattern of the set of non-uniform patterns in the frequency domain. Moreover, 804 may be performed by the component 198 in FIG. 12.

At 806, the UE may measure each PRS of the set of PRSs based on the corresponding non-uniform pattern of the set of non-uniform patterns in the frequency domain. For example, 806 may be performed by the UE 502 in FIG. 5, which may, at 512, measure each PRS of the set of PRSs based on the corresponding non-uniform pattern of the set of non-uniform patterns in the frequency domain. Moreover, 806 may be performed by the component 198 in FIG. 12.

At 808, the UE may receive DCI, a MAC-CE, or an RRC configuration including the PRS configuration. For example, 808 may be performed by the UE 502 in FIG. 5, which may receive DCI, a MAC-CE, or an RRC configuration including the PRS configuration. Moreover, 808 may be performed by the component 198 in FIG. 12.

At 810, the UE may receive an RRC configuration including a plurality of non-uniform patterns. For example, 810 may be performed by the UE 502 in FIG. 5, which may receive an RRC configuration including a plurality of non-uniform patterns. Moreover, 810 may be performed by the component 198 in FIG. 12.

At 812, the UE may receive DCI or a MAC-CE indicating a selection of the set of non-uniform patterns from the plurality of non-uniform patterns. For example, 812 may be performed by the UE 502 in FIG. 5, which may receive DCI or a MAC-CE indicating a selection of the set of non-uniform patterns from the plurality of non-uniform patterns. Moreover, 812 may be performed by the component 198 in FIG. 12.

At 814, the UE may calculate the non-uniform pattern based on at least one of a type of PRS pattern, a symbol offset, a slot offset, a frame index, or a periodicity. The PRS configuration may include at least one of the type of PRS pattern, the symbol offset, the slot offset, the frame index, or the periodicity. For example, 814 may be performed by the UE 502 in FIG. 5, which may calculate the non-uniform pattern based on at least one of a type of PRS pattern, a symbol offset, a slot offset, a frame index, or a periodicity. The PRS configuration may include at least one of the type of PRS pattern, the symbol offset, the slot offset, the frame index, or the periodicity. Moreover, 814 may be performed by the component 198 in FIG. 12.

At 816, the UE may receive a second PRS configuration that indicates a set of uniform patterns in the frequency domain for a second set of PRSs. The type of PRS pattern may indicate that the non-uniform pattern includes a first pattern that is not uniform in the frequency domain. For example, 816 may be performed by the UE 502 in FIG. 5, which may receive a second PRS configuration that indicates a set of uniform patterns in the frequency domain for a second set of PRSs. The type of PRS pattern may indicate that the non-uniform pattern includes a first pattern that is not uniform in the frequency domain. Moreover, 816 may be performed by the component 198 in FIG. 12.

At 818, the UE may calculate a uniform pattern of the set of uniform patterns based on the second PRS configuration. The second PRS configuration may indicate that the uniform pattern includes a second pattern that is uniform in the frequency domain. For example, 818 may be performed by the UE 502 in FIG. 5, which may calculate a uniform pattern of the set of uniform patterns based on the second PRS configuration. The second PRS configuration may indicate that the uniform pattern includes a second pattern that is uniform in the frequency domain. Moreover, 818 may be performed by the component 198 in FIG. 12.

At 820, the UE may receive the second set of PRSs based on the second PRS configuration. Each PRS of the second set of PRSs may be associated with a corresponding uniform pattern of the set of uniform patterns in the frequency domain. For example, 820 may be performed by the UE 502 in FIG. 5, which may receive the second set of PRSs based on the second PRS configuration. Each PRS of the second set of PRSs may be associated with a corresponding uniform pattern of the set of uniform patterns in the frequency domain. Moreover, 820 may be performed by the component 198 in FIG. 12.

At 822, the UE may measure each PRS of the second set of PRSs based on the corresponding uniform pattern of the set of uniform patterns in the frequency domain. For example, 822 may be performed by the UE 502 in FIG. 5, which may measure each PRS of the second set of PRSs based on the corresponding uniform pattern of the set of uniform patterns in the frequency domain. Moreover, 822 may be performed by the component 198 in FIG. 12.

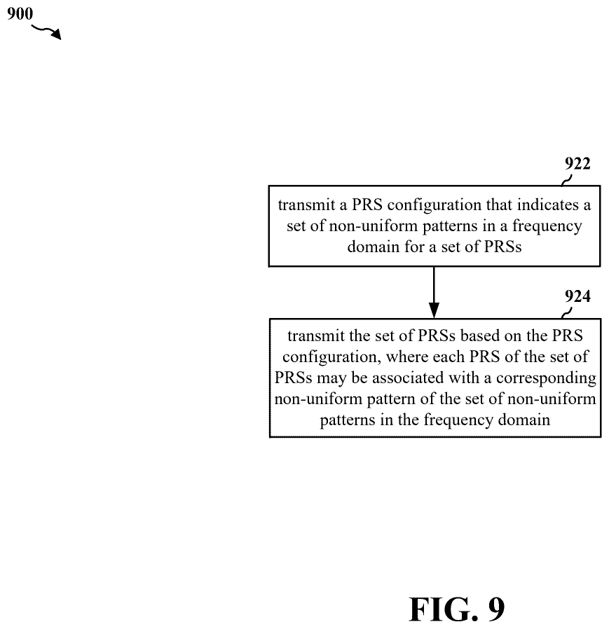

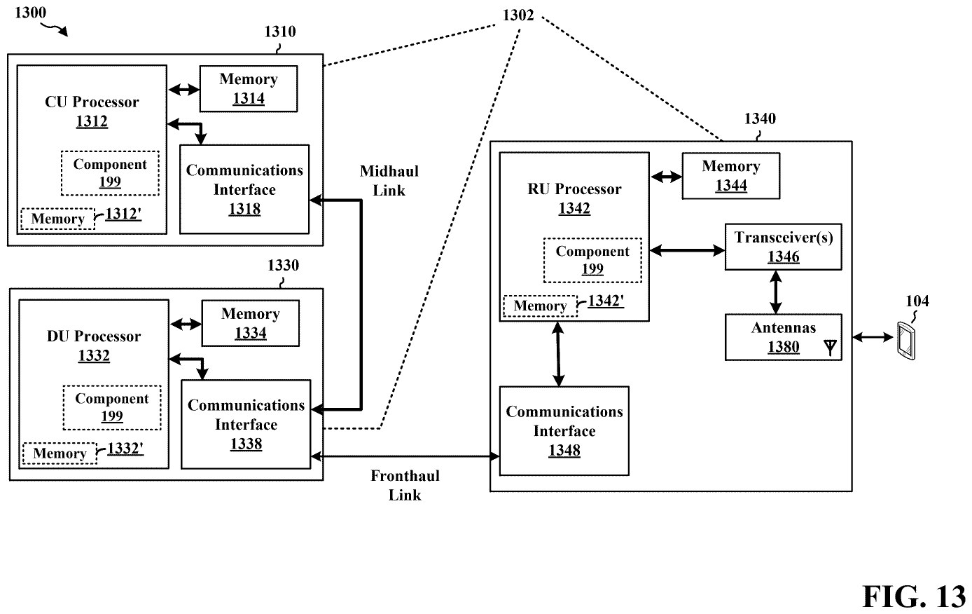

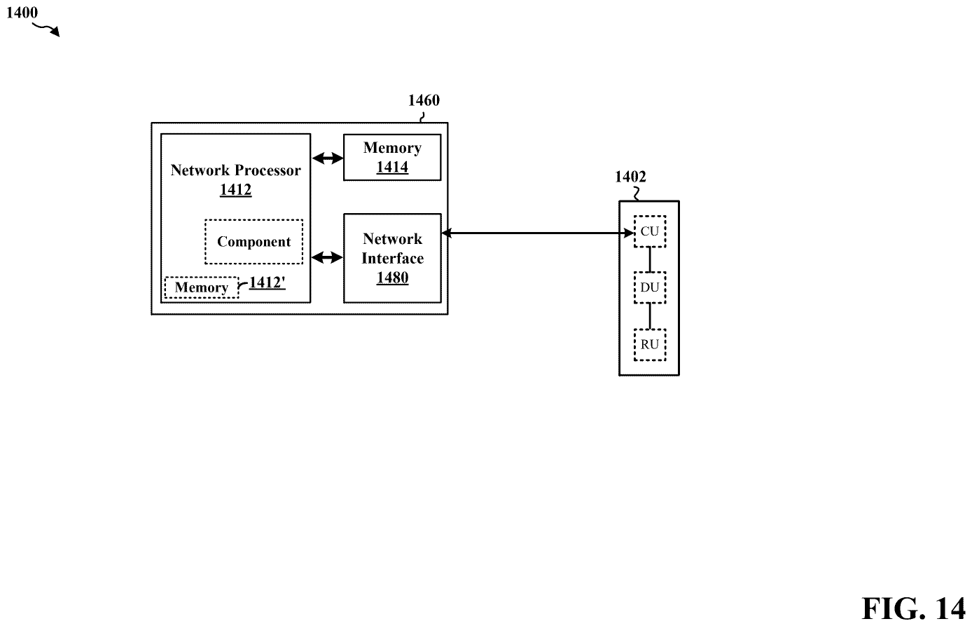

FIG. 9 is a flowchart 900 of a method of wireless communication. The method may be performed by a network node (e.g., the base station 102, the base station 310; the TRP 402, the TRP 406, the network node 504; the network entity 1202, the network entity 1302, the network entity 1460). At 922, the network node may transmit a PRS configuration that indicates a set of non-uniform patterns in a frequency domain for a set of PRSs. For example, 922 may be performed by the network node 504 in FIG. 5, which may transmit a PRS configuration 508 that indicates a set of non-uniform patterns, such as a nested pattern or a co-prime pattern, in a frequency domain for the set of PRSs 510. Moreover, 922 may be performed by the component 199 in FIG. 13 or 14.

At 924, the network node may transmit the set of PRSs based on the PRS configuration. Each PRS of the set of PRSs may be associated with a corresponding non-uniform pattern of the set of non-uniform patterns in the frequency domain. For example, 924 may be performed by the network node 504 in FIG. 5, which may transmit the set of PRSs 510 based on the PRS configuration 508. Each PRS of the set of PRSs 510 may be associated with a corresponding non-uniform pattern of the set of non-uniform patterns in the frequency domain. Moreover, 924 may be performed by the component 199 in FIG. 13 or 14.

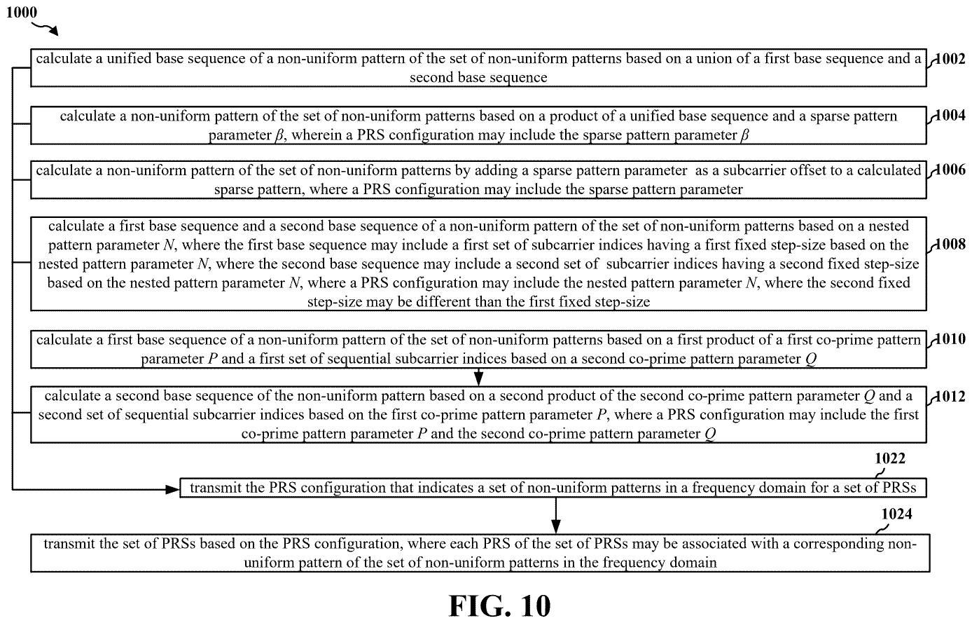

FIG. 10 is a flowchart 1000 of a method of wireless communication. The method may be performed by a network node (e.g., the base station 102, the base station 310; the TRP 402, the TRP 406, the network node 504; the network entity 1202, the network entity 1302, the network entity 1460). At 1002, the network node may calculate a combined base sequence of a non-uniform pattern of the set of non-uniform patterns based on a union of a first base sequence and a second base sequence. For example, 1002 may be performed by the network node 504 in FIG. 5, which may calculate a combined base sequence of a non-uniform pattern of the set of non-uniform patterns based on a union of a first base sequence and a second base sequence. Moreover, 1002 may be performed by the component 199 in FIG. 13 or 14.

At 1004, the network node may calculate a non-uniform pattern of the set of non-uniform patterns based on a product of a combined base sequence and a sparse pattern parameter β. A PRS configuration may include the sparse pattern parameter β. For example, 1004 may be performed by the network node 504 in FIG. 5, which may calculate a non-uniform pattern of the set of non-uniform patterns based on a product of a combined base sequence and a sparse pattern parameter β. A PRS configuration may include the sparse pattern parameter β. Moreover, 1004 may be performed by the component 199 in FIG. 13 or 14.

At 1006, the network node may calculate a non-uniform pattern of the set of non-uniform patterns by adding a sparse pattern parameter as a subcarrier offset to a calculated sparse pattern. A PRS configuration may include the sparse pattern parameter. For example, 1006 may be performed by the network node 504 in FIG. 5, which may calculate a non-uniform pattern of the set of non-uniform patterns by adding a sparse pattern parameter as a subcarrier offset to a calculated sparse pattern. A PRS configuration may include the sparse pattern parameter. Moreover, 1006 may be performed by the component 199 in FIG. 13 or 14.

At 1008, the network node may calculate a first base sequence and a second base sequence of a non-uniform pattern of the set of non-uniform patterns based on a nested pattern parameter N. The first base sequence may include a first set of subcarrier indices having a first fixed step-size based on the nested pattern parameter N. The second base sequence may include a second set of subcarrier indices having a second fixed step-size based on the nested pattern parameter N. A PRS configuration may include the nested pattern parameter N. The second fixed step-size may be different than the first fixed step-size. For example, 1008 may be performed by the network node 504 in FIG. 5, which may calculate a first base sequence and a second base sequence of a non-uniform pattern of the set of non-uniform patterns based on a nested pattern parameter N. The first base sequence may include a first set of subcarrier indices having a first fixed step-size based on the nested pattern parameter N. The second base sequence may include a second set of subcarrier indices having a second fixed step-size based on the nested pattern parameter N. A PRS configuration may include the nested pattern parameter N. The second fixed step-size may be different than the first fixed step-size. Moreover, 1008 may be performed by the component 199 in FIG. 13 or 14.

At 1010, the network node may calculate a first base sequence of a non-uniform pattern of the set of non-uniform patterns based on a first product of a first co-prime pattern parameter P and a first set of sequential subcarrier indices based on a second co-prime pattern parameter Q. For example, 1010 may be performed by the network node 504 in FIG. 5, which may calculate a first base sequence of a non-uniform pattern of the set of non-uniform patterns based on a first product of a first co-prime pattern parameter P and a first set of sequential subcarrier indices based on a second co-prime pattern parameter Q. Moreover, 1010 may be performed by the component 199 in FIG. 13 or 14.

At 1012, the network node may calculate a second base sequence of the non-uniform pattern based on a second product of the second co-prime pattern parameter Q and a second set of sequential subcarrier indices based on the first co-prime pattern parameter P. A PRS configuration may include the first co-prime pattern parameter P and the second co-prime pattern parameter Q. For example, 1012 may be performed by the network node 504 in FIG. 5, which may calculate a second base sequence of the non-uniform pattern based on a second product of the second co-prime pattern parameter Q and a second set of sequential subcarrier indices based on the first co-prime pattern parameter P. A PRS configuration may include the first co-prime pattern parameter P and the second co-prime pattern parameter. Moreover, 1012 may be performed by the component 199 in FIG. 13 or 14.

At 1022, the network node may transmit the PRS configuration that indicates a set of non-uniform patterns in a frequency domain for a set of PRSs. For example, 1022 may be performed by the network node 504 in FIG. 5, which may transmit the PRS configuration 508 that indicates a set of non-uniform patterns, such as a nested pattern or a co-prime pattern, in a frequency domain for the set of PRSs 510. Moreover, 1022 may be performed by the component 199 in FIG. 13 or 14.

At 1024, the network node may transmit the set of PRSs based on the PRS configuration. Each PRS of the set of PRSs may be associated with a corresponding non-uniform pattern of the set of non-uniform patterns in the frequency domain. For example, 1024 may be performed by the network node 504 in FIG. 5, which may transmit the set of PRSs 510 based on the PRS configuration 508. Each PRS of the set of PRSs 510 may be associated with a corresponding non-uniform pattern of the set of non-uniform patterns in the frequency domain. Moreover, 1024 may be performed by the component 199 in FIG. 13 or 14.

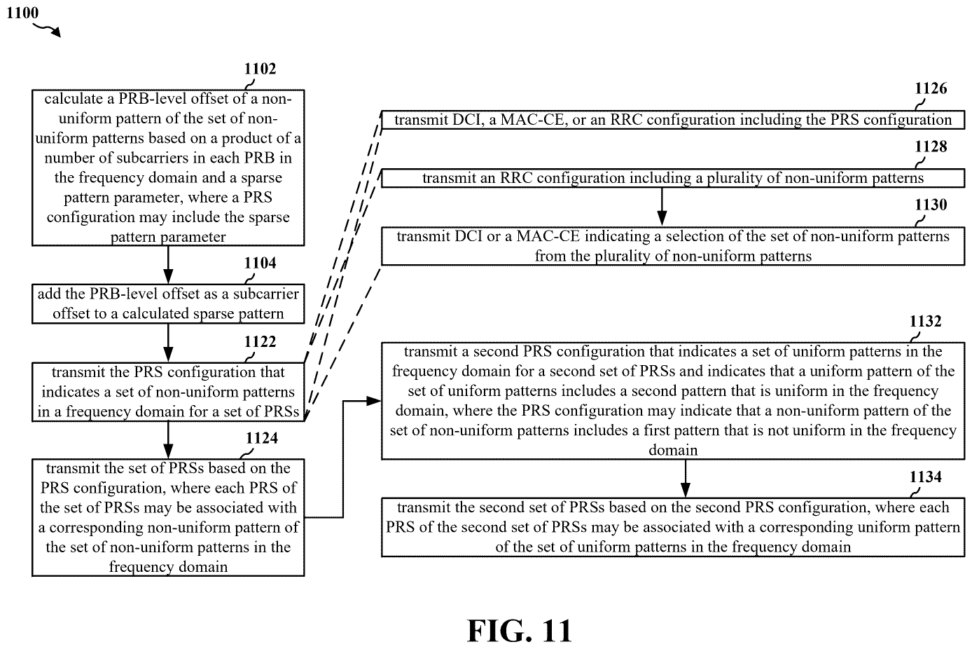

FIG. 11 is a flowchart 1100 of a method of wireless communication. The method may be performed by a network node (e.g., the base station 102, the base station 310; the TRP 402, the TRP 406, the network node 504; the network entity 1202, the network entity 1302, the network entity 1460). At 1102, the network node may calculate a PRB-level offset of a non-uniform pattern of the set of non-uniform patterns based on a product of a number of subcarriers in each PRB in the frequency domain and a sparse pattern parameter. A PRS configuration may include the sparse pattern parameter. For example, 1102 may be performed by the network node 504 in FIG. 5, which may calculate a PRB-level offset of a non-uniform pattern of the set of non-uniform patterns based on a product of a number of subcarriers in each PRB in the frequency domain and a sparse pattern parameter. A PRS configuration may include the sparse pattern parameter. Moreover, 1102 may be performed by the component 199 in FIG. 13 or 14.

At 1104, the network node may add the PRB-level offset as a subcarrier offset to a calculated sparse pattern. For example, 1104 may be performed by the network node 504 in FIG. 5, which may add the PRB-level offset as a subcarrier offset to a calculated sparse pattern. Moreover, 1104 may be performed by the component 199 in FIG. 13 or 14.

At 1122, the network node may transmit the PRS configuration that indicates a set of non-uniform patterns in a frequency domain for a set of PRSs. For example, 1122 may be performed by the network node 504 in FIG. 5, which may transmit the PRS configuration 508 that indicates a set of non-uniform patterns, such as a nested pattern or a co-prime pattern, in a frequency domain for the set of PRSs 510. Moreover, 1122 may be performed by the component 199 in FIG. 13 or 14.

At 1124, the network node may transmit the set of PRSs based on the PRS configuration. Each PRS of the set of PRSs may be associated with a corresponding non-uniform pattern of the set of non-uniform patterns in the frequency domain. For example, 1124 may be performed by the network node 504 in FIG. 5, which may transmit the set of PRSs 510 based on the PRS configuration 508. Each PRS of the set of PRSs 510 may be associated with a corresponding non-uniform pattern of the set of non-uniform patterns in the frequency domain. Moreover, 1124 may be performed by the component 199 in FIG. 13 or 14.

At 1126, the network node may transmit DCI, a MAC-CE, or an RRC configuration including the PRS configuration. For example, 1126 may be performed by the network node 504 in FIG. 5, which may transmit DCI, a MAC-CE, or an RRC configuration including the PRS configuration. Moreover, 1126 may be performed by the component 199 in FIG. 13 or 14.

At 1128, the network node may transmit an RRC configuration including a plurality of non-uniform patterns. For example, 1128 may be performed by the network node 504 in FIG. 5, which may transmit an RRC configuration including a plurality of non-uniform patterns. Moreover, 1128 may be performed by the component 199 in FIG. 13 or 14.

At 1130, the network node may transmit DCI or a MAC-CE indicating a selection of the set of non-uniform patterns from the plurality of non-uniform patterns. For example, 1130 may be performed by the network node 504 in FIG. 5, which may transmit DCI or a MAC-CE indicating a selection of the set of non-uniform patterns from the plurality of non-uniform patterns. Moreover, 1130 may be performed by the component 199 in FIG. 13 or 14.

At 1132, the network node may transmit a second PRS configuration that indicates a set of uniform patterns in the frequency domain for a second set of PRSs and indicates that a uniform pattern of the set of uniform patterns includes a second pattern that is uniform in the frequency domain. The PRS configuration may indicate that a non-uniform pattern of the set of non-uniform patterns includes a first pattern that is not uniform in the frequency domain. For example, 1132 may be performed by the network node 504 in FIG. 5, which may transmit a second PRS configuration that indicates a set of uniform patterns in the frequency domain for a second set of PRSs and indicates that a uniform pattern of the set of uniform patterns includes a second pattern that is uniform in the frequency domain. The PRS configuration may indicate that a non-uniform pattern of the set of non-uniform patterns includes a first pattern that is not uniform in the frequency domain. Moreover, 1132 may be performed by the component 199 in FIG. 13 or 14.

At 1134, the network node may transmit the second set of PRSs based on the second PRS configuration. Each PRS of the second set of PRSs may be associated with a corresponding uniform pattern of the set of uniform patterns in the frequency domain. For example, 1134 may be performed by the network node 504 in FIG. 5, which may transmit the second set of PRSs based on the second PRS configuration. Each PRS of the second set of PRSs may be associated with a corresponding uniform pattern of the set of uniform patterns in the frequency domain. Moreover, 1134 may be performed by the component 199 in FIG. 13 or 14.

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include a cellular baseband processor 1224 (also referred to as a modem) coupled to one or more transceivers 1222 (e.g., cellular RF transceiver). The cellular baseband processor 1224 may include on-chip memory 1224′. In some aspects, the apparatus 1204 may further include one or more subscriber identity modules (SIM) cards 1220 and an application processor 1206 coupled to a secure digital (SD) card 1208 and a screen 1210. The application processor 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (Rx)). The Bluetooth module 1212, the WLAN module 1214, and the SPS module 1216 may include their own dedicated antennas and/or utilize the antennas 1280 for communication. The cellular baseband processor 1224 communicates through the transceiver(s) 1222 via one or more antennas 1280 with the UE 104 and/or with an RU associated with a network entity 1202. The cellular baseband processor 1224 and the application processor 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor 1224 and the application processor 1206 are each responsible for general processing, including the execution of software stored on the computer-readable medium/memory. The software, when executed by the cellular baseband processor 1224/application processor 1206, causes the cellular baseband processor 1224/application processor 1206 to perform the various functions described supra. The computer-readable medium/memory may also be used for storing data that is manipulated by the cellular baseband processor 1224/application processor 1206 when executing software. The cellular baseband processor 1224/application processor 1206 may be a component of the UE 350 and may include the memory 360 and/or at least one of the Tx processor 368, the Rx processor 356, and the controller/processor 359. In one configuration, the apparatus 1204 may be a processor chip (modem and/or application) and include just the cellular baseband processor 1224 and/or the application processor 1206, and in another configuration, the apparatus 1204 may be the entire UE (e.g., see UE 350 of FIG. 3) and include the additional modules of the apparatus 1204.

As discussed supra, the component 198 may be configured to receive a PRS configuration that indicates a set of non-uniform patterns in a frequency domain for a set of PRSs. The component 198 may receive the set of PRSs based on the PRS configuration. Each PRS of the set of PRSs may be associated with a corresponding non-uniform pattern of the set of non-uniform patterns in the frequency domain. The component 198 may measure each PRS of the set of PRSs based on the corresponding non-uniform pattern of the set of non-uniform patterns in the frequency domain. The component 198 may be within the cellular baseband processor 1224, the application processor 1206, or both the cellular baseband processor 1224 and the application processor 1206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1204 may include a variety of components configured for various functions. In one configuration, the apparatus 1204, and in particular the cellular baseband processor 1224 and/or the application processor 1206, may include means for receiving a PRS configuration that indicates a set of non-uniform patterns in a frequency domain for a set of PRSs. The apparatus 1204 may include means for receiving the set of PRSs based on the PRS configuration. Each PRS of the set of PRSs may be associated with a corresponding non-uniform pattern of the set of non-uniform patterns in the frequency domain. The apparatus 1204 may include means for measuring each PRS of the set of PRSs based on the corresponding non-uniform pattern of the set of non-uniform patterns in the frequency domain. The set of non-uniform patterns may include at least one of a nested pattern or a co-prime pattern. The apparatus 1204 may include means for calculating a non-uniform pattern of the set of non-uniform patterns based on the PRS configuration. The PRS configuration may include a nested pattern parameter N. The apparatus 1204 may include means for calculating the non-uniform pattern by calculating a first base sequence and a second base sequence of the non-uniform pattern based on the nested pattern parameter N. The first base sequence may include a set of subcarrier indices having a first fixed step-size based on the nested pattern parameter N. The second base sequence may include a set of subcarrier indices having a second fixed step-size based on the nested pattern parameter N. The second fixed step-size may be different than the first fixed step-size. The PRS configuration may include a first co-prime pattern parameter P and a second co-prime pattern parameter Q. The apparatus 1204 may include means for calculating the non-uniform pattern by calculating a first base sequence of the non-uniform pattern based on a first product of the first co-prime pattern parameter P and a first set of sequential subcarrier indices based on the second co-prime pattern parameter Q. The apparatus 1204 may include means for calculating the non-uniform pattern by calculating a second base sequence of the non-uniform pattern based on a second product of the second co-prime pattern parameter Q and a second set of sequential subcarrier indices based on the first co-prime pattern parameter P. The apparatus 1204 may include means for calculating the non-uniform pattern by calculating a combined base sequence of the non-uniform pattern based on the union of a first base sequence and a second base sequence. The PRS configuration may include a sparse pattern parameter β. The apparatus 1204 may include means for calculating the non-uniform pattern by calculating the non-uniform pattern based on a product of a combined base sequence and the sparse pattern parameter β. The PRS configuration may include a sparse pattern parameter K_{PRB}. The apparatus 1204 may include means for calculating the non-uniform pattern by calculating a PRB-level offset of the non-uniform pattern based on a product of a number of subcarriers in each PRB in the frequency domain and the sparse pattern parameter K_{PRB}. The apparatus 1204 may include means for calculating the non-uniform pattern by adding the PRB-level offset as a subcarrier offset to a calculated sparse pattern. The PRS configuration may include a sparse pattern parameter K_{subc}. The apparatus 1204 may include means for calculating the non-uniform pattern by adding the sparse pattern parameter K_{subc} as a subcarrier offset to a calculated sparse pattern. The PRS configuration may include at least one of a type of PRS pattern, a symbol offset, a slot offset, a frame index, or a periodicity. The apparatus 1204 may include means for calculating the non-uniform pattern by calculating the non-uniform pattern based on at least one of the type of PRS pattern, the symbol offset, the slot offset, the frame index, or the periodicity. The type of PRS pattern may indicate that the non-uniform pattern includes a first pattern that is not uniform in the frequency domain. The apparatus 1204 may include means for receiving a second PRS configuration that indicates a set of uniform patterns in the frequency domain for a second set of PRSs. The apparatus 1204 may include means for calculating a uniform pattern of the set of uniform patterns based on the second PRS configuration. The second PRS configuration may indicate that the uniform pattern includes a second pattern that is uniform in the frequency domain. The apparatus 1204 may include means for receiving the second set of PRSs based on the second PRS configuration. Each PRS of the second set of PRSs may be associated with a corresponding uniform pattern of the set of uniform patterns in the frequency domain. The apparatus 1204 may include means for measuring each PRS of the second set of PRSs based on the corresponding uniform pattern of the set of uniform patterns in the frequency domain. The apparatus 1204 may include means for receiving the PRS configuration by receiving DCI, a MAC-CE, or an RRC configuration including the PRS configuration. The apparatus 1204 may include means for receiving the PRS configuration by receiving an RRC configuration including a plurality of non-uniform patterns. The apparatus 1204 may include means for receiving the PRS configuration by receiving DCI or a MAC-CE indicating a selection of the set of non-uniform patterns from the plurality of non-uniform patterns. The means may be the component 198 of the apparatus 1204 configured to perform the functions recited by the means. As described supra, the apparatus 1204 may include the Tx processor 368, the Rx processor 356, and the controller/processor 359. As such, in one configuration, the means may be the Tx processor 368, the Rx processor 356, and/or the controller/processor 359 configured to perform the functions recited by the means.

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include a CU processor 1312. The CU processor 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include a DU processor 1332. The DU processor 1332 may include on-chip memory 1332′. In some aspects, the DU 1330 may further include additional memory modules 1334 and a communications interface 1338. The DU 1330 communicates with the RU 1340 through a fronthaul link. The RU 1340 may include an RU processor 1342. The RU processor 1342 may include on-chip memory 1342′. In some aspects, the RU 1340 may further include additional memory modules 1344, one or more transceivers 1346, antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit a PRS configuration that indicates a set of non-uniform patterns in a frequency domain for a set of PRSs. The component 199 may transmit the set of PRSs based on the PRS configuration. Each PRS of the set of PRSs may be associated with a corresponding non-uniform pattern of the set of non-uniform patterns in the frequency domain. The component 199 may be within one or more processors of one or more of the CU 1310, DU 1330, and the RU 1340. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1302 may include a variety of components configured for various functions. In one configuration, the network entity 1302 may include means for transmitting a PRS configuration that indicates a set of non-uniform patterns in a frequency domain for a set of PRSs. The network entity 1302 may include means for transmitting the set of PRSs based on the PRS configuration. Each PRS of the set of PRSs may be associated with a corresponding non-uniform pattern of the set of non-uniform patterns in the frequency domain. The set of non-uniform patterns may include at least one of a nested pattern or a co-prime pattern. The network entity 1302 may include means for calculating a first base sequence and a second base sequence of a non-uniform pattern of the set of non-uniform patterns based on a nested pattern parameter N. The first base sequence may include a set of subcarrier indices having a first fixed step-size based on the nested pattern parameter N. The second base sequence may include a set of subcarrier indices having a second fixed step-size based on the nested pattern parameter N. The PRS configuration may include the nested pattern parameter N. The second fixed step-size may be different than the first fixed step-size. The network entity 1302 may include means for calculating a first base sequence of a non-uniform pattern of the set of non-uniform patterns based on a first product of a first co-prime pattern parameter P and a first set of sequential subcarrier indices based on a second co-prime pattern parameter Q. The method may include calculating a second base sequence of the non-uniform pattern based on a second product of the second co-prime pattern parameter Q and a second set of sequential subcarrier indices based on the first co-prime pattern parameter P. The PRS configuration may include the first co-prime pattern parameter P and the second co-prime pattern parameter Q. The network entity 1302 may include means for calculating a combined base sequence of a non-uniform pattern of the set of non-uniform patterns based on the union of a first base sequence and a second base sequence. The network entity 1302 may include means for calculating a non-uniform pattern of the set of non-uniform patterns based on a product of a combined base sequence and a sparse pattern parameter β. The PRS configuration may include the sparse pattern parameter β. The network entity 1302 may include means for calculating a PRB-level offset of a non-uniform pattern of the set of non-uniform patterns based on a product of a number of subcarriers in each PRB in the frequency domain and a sparse pattern parameter K_{PRB}. The PRS configuration may include the sparse pattern parameter K_{PRB}. The network entity 1302 may include means for adding the PRB-level offset as a subcarrier offset to a calculated sparse pattern. The network entity 1302 may include means for calculating a non-uniform pattern of the set of non-uniform patterns by adding a sparse pattern parameter K_{subc} as a subcarrier offset to a calculated sparse pattern. The PRS configuration may include the sparse pattern parameter K_{subc}. The PRS configuration may indicate that a non-uniform pattern of the set of non-uniform patterns includes a first pattern that is not uniform in the frequency domain. The network entity 1302 may include means for transmitting a second PRS configuration that indicates a set of uniform patterns in the frequency domain for a second set of PRSs and indicates that a uniform pattern of the set of uniform patterns includes a second pattern that is uniform in the frequency domain. The network entity 1302 may include means for transmitting the second set of PRSs based on the second PRS configuration. Each PRS of the second set of PRSs may be associated with a corresponding uniform pattern of the set of uniform patterns in the frequency domain. The network entity 1302 may include means for transmitting the PRS configuration by transmitting DCI, a MAC-CE, or an RRC configuration including the PRS configuration. The network entity 1302 may include means for transmitting the PRS configuration by transmitting an RRC configuration including a plurality of non-uniform patterns. The network entity 1302 may include means for transmitting the PRS configuration by transmitting DCI or a MAC-CE indicating a selection of the set of non-uniform patterns from the plurality of non-uniform patterns. The means may be the component 199 of the network entity 1302 configured to perform the functions recited by the means. As described supra, the network entity 1302 may include the Tx processor 316, the Rx processor 370, and the controller/processor 375. As such, in one configuration, the means may be the Tx processor 316, the Rx processor 370, and/or the controller/processor 375 configured to perform the functions recited by the means.

FIG. 14 is a diagram 1400 illustrating an example of a hardware implementation for a network entity 1460. In one example, the network entity 1460 may be within the core network 120. The network entity 1460 may include a network processor 1412. The network processor 1412 may include on-chip memory 1412′. In some aspects, the network entity 1460 may further include additional memory modules 1414. The network entity 1460 communicates via the network interface 1480 directly (e.g., backhaul link) or indirectly (e.g., through a RIC) with the CU 1402. The on-chip memory 1412′ and the additional memory modules 1414 may each be considered a computer-readable medium/memory. Each computer-readable medium/memory may be non-transitory. The processor 1412 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit a PRS configuration that indicates a set of non-uniform patterns in a frequency domain for a set of PRSs. The component 199 may transmit the set of PRSs based on the PRS configuration. Each PRS of the set of PRSs may be associated with a corresponding non-uniform pattern of the set of non-uniform patterns in the frequency domain. The component 199 may be within the processor 1412. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1460 may include a variety of components configured for various functions. In one configuration, the network entity 1460 may include means for transmitting a PRS configuration that indicates a set of non-uniform patterns in a frequency domain for a set of PRSs. The network entity 1460 may include means for transmitting the set of PRSs based on the PRS configuration. Each PRS of the set of PRSs may be associated with a corresponding non-uniform pattern of the set of non-uniform patterns in the frequency domain. The set of non-uniform patterns may include at least one of a nested pattern or a co-prime pattern. The network entity 1460 may include means for calculating a first base sequence and a second base sequence of a non-uniform pattern of the set of non-uniform patterns based on a nested pattern parameter N. The first base sequence may include a set of subcarrier indices having a first fixed step-size based on the nested pattern parameter N. The second base sequence may include a set of subcarrier indices having a second fixed step-size based on the nested pattern parameter N. The PRS configuration may include the nested pattern parameter N. The second fixed step-size may be different than the first fixed step-size. The network entity 1460 may include means for calculating a first base sequence of a non-uniform pattern of the set of non-uniform patterns based on a first product of a first co-prime pattern parameter P and a first set of sequential subcarrier indices based on a second co-prime pattern parameter Q. The method may include calculating a second base sequence of the non-uniform pattern based on a second product of the second co-prime pattern parameter Q and a second set of sequential subcarrier indices based on the first co-prime pattern parameter P. The PRS configuration may include the first co-prime pattern parameter P and the second co-prime pattern parameter Q. The network entity 1460 may include means for calculating a combined base sequence of a non-uniform pattern of the set of non-uniform patterns based on the union of a first base sequence and a second base sequence. The network entity 1460 may include means for calculating a non-uniform pattern of the set of non-uniform patterns based on a product of a combined base sequence and a sparse pattern parameter β. The PRS configuration may include the sparse pattern parameter β. The network entity 1460 may include means for calculating a PRB-level offset of a non-uniform pattern of the set of non-uniform patterns based on a product of a number of subcarriers in each PRB in the frequency domain and a sparse pattern parameter K_{PRB}. The PRS configuration may include the sparse pattern parameter K_{PRB}. The network entity 1460 may include means for adding the PRB-level offset as a subcarrier offset to a calculated sparse pattern. The network entity 1460 may include means for calculating a non-uniform pattern of the set of non-uniform patterns by adding a sparse pattern parameter K_{subc} as a subcarrier offset to a calculated sparse pattern. The PRS configuration may include the sparse pattern parameter K_{subc}. The PRS configuration may indicate that a non-uniform pattern of the set of non-uniform patterns includes a first pattern that is not uniform in the frequency domain. The network entity 1460 may include means for transmitting a second PRS configuration that indicates a set of uniform patterns in the frequency domain for a second set of PRSs and indicates that a uniform pattern of the set of uniform patterns includes a second pattern that is uniform in the frequency domain. The network entity 1460 may include means for transmitting the second set of PRSs based on the second PRS configuration. Each PRS of the second set of PRSs may be associated with a corresponding uniform pattern of the set of uniform patterns in the frequency domain. The network entity 1460 may include means for transmitting the PRS configuration by transmitting DCI, a MAC-CE, or an RRC configuration including the PRS configuration. The network entity 1460 may include means for transmitting the PRS configuration by transmitting an RRC configuration including a plurality of non-uniform patterns. The network entity 1460 may include means for transmitting the PRS configuration by transmitting DCI or a MAC-CE indicating a selection of the set of non-uniform patterns from the plurality of non-uniform patterns. The means may be the component 199 of the network entity 1460 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data.

The following aspects are illustrative only and may be combined with other aspects or teachings described herein, without limitation.
Aspect 1 is a method of wireless communication at a UE, where the method may include receiving a PRS configuration that indicates a set of non-uniform patterns in a frequency domain for a set of PRSs. The method may include receiving the set of PRSs based on the PRS configuration. Each PRS of the set of PRSs may be associated with a corresponding non-uniform pattern of the set of non-uniform patterns in the frequency domain. The method may include measuring each PRS of the set of PRSs based on the corresponding non-uniform pattern of the set of non-uniform patterns in the frequency domain.
Aspect 2 is the method of aspect 1, where the set of non-uniform patterns may include at least one of a nested pattern or a co-prime pattern.
Aspect 3 is the method of any of aspects 1 and 2, where the method may include calculating a non-uniform pattern of the set of non-uniform patterns based on the PRS configuration.
Aspect 4 is the method of aspect 3, where the PRS configuration may include a nested pattern parameter N. Calculating the non-uniform pattern may include calculating a first base sequence and a second base sequence of the non-uniform pattern based on the nested pattern parameter N. The first base sequence may include a set of subcarrier indices having a first fixed step-size based on the nested pattern parameter N. The second base sequence may include a set of subcarrier indices having a second fixed step-size based on the nested pattern parameter N. The second fixed step-size may be different than the first fixed step-size.
Aspect 5 is the method of aspect 3, where the PRS configuration may include a first co-prime pattern parameter P and a second co-prime pattern parameter Q. Calculating the non-uniform pattern may include calculating a first base sequence of the non-uniform pattern based on a first product of the first co-prime pattern parameter P and a first set of sequential subcarrier indices based on the second co-prime pattern parameter Q. Calculating the non-uniform pattern may include calculating a second base sequence of the non-uniform pattern based on a second product of the second co-prime pattern parameter Q and a second set of sequential subcarrier indices based on the first co-prime pattern parameter P.
Aspect 6 is the method of any of aspects 3 to 5, where calculating the non-uniform pattern may include calculating a combined base sequence of the non-uniform pattern based on the union of a first base sequence and a second base sequence.
Aspect 7 is the method of any of aspects 3 to 6, where the PRS configuration may include a sparse pattern parameter β. Calculating the non-uniform pattern may include calculating the non-uniform pattern based on a product of a combined base sequence and the sparse pattern parameter β.
Aspect 8 is the method of any of aspects 3 to 7, where the PRS configuration may include a sparse pattern parameter K_{PRB}. Calculating the non-uniform pattern may include calculating a PRB-level offset of the non-uniform pattern based on a product of a number of subcarriers in each PRB in the frequency domain and the sparse pattern parameter K_{PRB}. Calculating the non-uniform pattern may include adding the PRB-level offset as a subcarrier offset to a calculated sparse pattern.
Aspect 9 is the method of any of aspects 3 to 8, where the PRS configuration may include a sparse pattern parameter K_{subc}. Calculating the non-uniform pattern may include adding the sparse pattern parameter K_{subc} as a subcarrier offset to a calculated sparse pattern.
Aspect 10 is the method of any of aspects 3 to 9, where the PRS configuration may include at least one of a type of PRS pattern, a symbol offset, a slot offset, a frame index, or a periodicity. Calculating the non-uniform pattern may include calculating the non-uniform pattern based on at least one of the type of PRS pattern, the symbol offset, the slot offset, the frame index, or the periodicity.
Aspect 11 is the method of aspect 10, where the type of PRS pattern may indicate that the non-uniform pattern includes a first pattern that is not uniform in the frequency domain. The method may include receiving a second PRS configuration that indicates a set of uniform patterns in the frequency domain for a second set of PRSs. The method may include calculating a uniform pattern of the set of uniform patterns based on the second PRS configuration. The second PRS configuration may indicate that the uniform pattern includes a second pattern that is uniform in the frequency domain. The method may include receiving the second set of PRSs based on the second PRS configuration. Each PRS of the second set of PRSs may be associated with a corresponding uniform pattern of the set of uniform patterns in the frequency domain. The method may include measuring each PRS of the second set of PRSs based on the corresponding uniform pattern of the set of uniform patterns in the frequency domain.
Aspect 12 is the method of any of aspects 1 to 11, where receiving the PRS configuration may include receiving DCI, a MAC-CE, or an RRC configuration including the PRS configuration.
Aspect 13 is the method of any of aspects 1 to 12, where receiving the PRS configuration may include receiving an RRC configuration including a plurality of non-uniform patterns. Receiving the PRS configuration may include receiving DCI or a MAC-CE indicating a selection of the set of non-uniform patterns from the plurality of non-uniform patterns.
Aspect 14 is a method of wireless communication at a network node, where the method may include transmitting a PRS configuration that indicates a set of non-uniform patterns in a frequency domain for a set of PRSs. The method may include transmitting the set of PRSs based on the PRS configuration. Each PRS of the set of PRSs may be associated with a corresponding non-uniform pattern of the set of non-uniform patterns in the frequency domain.
Aspect 15 is the method of aspect 14, where the set of non-uniform patterns may include at least one of a nested pattern or a co-prime pattern.
Aspect 16 is the method of either of aspects 14 or 15, where the method may include calculating a first base sequence and a second base sequence of a non-uniform pattern of the set of non-uniform patterns based on a nested pattern parameter N. The first base sequence may include a set of subcarrier indices having a first fixed step-size based on the nested pattern parameter N. The second base sequence may include a set of subcarrier indices having a second fixed step-size based on the nested pattern parameter N. The PRS configuration may include the nested pattern parameter N. The second fixed step-size may be different than the first fixed step-size.
Aspect 17 is the method of any of aspects 14 to 16, where the method may include calculating a first base sequence of a non-uniform pattern of the set of non-uniform patterns based on a first product of a first co-prime pattern parameter P and a first set of sequential subcarrier indices based on a second co-prime pattern parameter Q. The method may include calculating a second base sequence of the non-uniform pattern based on a second product of the second co-prime pattern parameter Q and a second set of sequential subcarrier indices based on the first co-prime pattern parameter P. The PRS configuration may include the first co-prime pattern parameter P and the second co-prime pattern parameter Q.
Aspect 18 is the method of any of aspects 14 to 17, where the method may include calculating a combined base sequence of a non-uniform pattern of the set of non-uniform patterns based on the union of a first base sequence and a second base sequence.
Aspect 19 is the method of any of aspects 14 to 18, where the method may include calculating a non-uniform pattern of the set of non-uniform patterns based on a product of a combined base sequence and a sparse pattern parameter β. The PRS configuration may include the sparse pattern parameter β.
Aspect 20 is the method of any of aspects 14 to 19, where the method may include calculating a PRB-level offset of a non-uniform pattern of the set of non-uniform patterns based on a product of a number of subcarriers in each PRB in the frequency domain and a sparse pattern parameter K_{PRB}. The PRS configuration may include the sparse pattern parameter K_{PRB}. The method may include adding the PRB-level offset as a subcarrier offset to a calculated sparse pattern.
Aspect 21 is the method of any of aspects 14 to 20, where the method may include calculating a non-uniform pattern of the set of non-uniform patterns by adding a sparse pattern parameter K_{subc} as a subcarrier offset to a calculated sparse pattern. The PRS configuration may include the sparse pattern parameter K_{subc}.
Aspect 22 is the method of any of aspects 14 to 21, where the PRS configuration may indicate that a non-uniform pattern of the set of non-uniform patterns includes a first pattern that is not uniform in the frequency domain. The method may include transmitting a second PRS configuration that indicates a set of uniform patterns in the frequency domain for a second set of PRSs and indicates that a uniform pattern of the set of uniform patterns includes a second pattern that is uniform in the frequency domain. The method may include transmitting the second set of PRSs based on the second PRS configuration. Each PRS of the second set of PRSs may be associated with a corresponding uniform pattern of the set of uniform patterns in the frequency domain.
Aspect 23 is the method of any of aspects 14 to 22, where transmitting the PRS configuration may include transmitting DCI, a MAC-CE, or an RRC configuration including the PRS configuration.
Aspect 24 is the method of any of aspects 14 to 23, where transmitting the PRS configuration may include transmitting an RRC configuration including a plurality of non-uniform patterns. Transmitting the PRS configuration may include transmitting DCI or a MAC-CE indicating a selection of the set of non-uniform patterns from the plurality of non-uniform patterns.
Aspect 25 is an apparatus for wireless communication, including: a memory; and at least one processor coupled to the memory and, based at least in part on information stored in the memory, the at least one processor is configured to implement any of aspects 1 to 24.
Aspect 26 is the apparatus of aspect 25, further including at least one of an antenna or a transceiver coupled to the at least one processor.
Aspect 27 is an apparatus for wireless communication including means for implementing any of aspects 1 to 24.
Aspect 28 is a computer-readable medium (e.g., a non-transitory computer-readable medium) storing computer executable code, where the code when executed by a processor causes the processor to implement any of aspects 1 to 24.

1. An apparatus for wireless communication at a user equipment (UE), comprising:
a memory; and
at least one processor coupled to the memory and, based at least in part on information stored in the memory, the at least one processor is configured to:
receive a positioning reference signal (PRS) configuration that indicates a set of non-uniform patterns in a frequency domain for a set of PRSs;
receive the set of PRSs based on the PRS configuration, wherein each PRS of the set of PRSs is associated with a corresponding non-uniform pattern of the set of non-uniform patterns in the frequency domain; and
measure each PRS of the set of PRSs based on the corresponding non-uniform pattern of the set of non-uniform patterns in the frequency domain.

2. The apparatus of claim 1, wherein the set of non-uniform patterns comprises at least one of a nested pattern or a co-prime pattern.

3. The apparatus of claim 1, wherein the at least one processor is further configured to:
calculate a non-uniform pattern of the set of non-uniform patterns based on the PRS configuration.

4. The apparatus of claim 3, wherein the PRS configuration comprises a nested pattern parameter N, wherein, to calculate the non-uniform pattern, the at least one processor is configured to:
calculate a first base sequence and a second base sequence of the non-uniform pattern based on the nested pattern parameter N, wherein the first base sequence comprises a first set of subcarrier indices having a first fixed step-size based on the nested pattern parameter N, wherein the second base sequence comprises a second set of subcarrier indices having a second fixed step-size based on the nested pattern parameter N, wherein the second fixed step-size is different than the first fixed step-size.

5. The apparatus of claim 3, wherein the PRS configuration comprises a first co-prime pattern parameter P and a second co-prime pattern parameter Q, wherein, to calculate the non-uniform pattern, the at least one processor is configured to:
calculate a first base sequence of the non-uniform pattern based on a first product of the first co-prime pattern parameter P and a first set of sequential subcarrier indices based on the second co-prime pattern parameter Q; and
calculate a second base sequence of the non-uniform pattern based on a second product of the second co-prime pattern parameter Q and a second set of sequential subcarrier indices based on the first co-prime pattern parameter P.

6. The apparatus of claim 3, wherein, to calculate the non-uniform pattern, the at least one processor is configured to:
calculate a combined base sequence of the non-uniform pattern based on a union of a first base sequence and a second base sequence.

7. The apparatus of claim 3, wherein the PRS configuration comprises a sparse pattern parameter β, wherein, to calculate the non-uniform pattern, the at least one processor is configured to:
calculate the non-uniform pattern based on a product of a combined base sequence and the sparse pattern parameter β.

8. The apparatus of claim 3, wherein the PRS configuration comprises a sparse pattern parameter K_{PRB}, wherein, to calculate the non-uniform pattern, the at least one processor is configured to:
calculate a physical resource block level (PRB-level) offset of the non-uniform pattern based on a product of a number of subcarriers in each PRB in the frequency domain and the sparse pattern parameter K_{PRB}; and
add the PRB-level offset as a subcarrier offset to a calculated sparse pattern.

9. The apparatus of claim 3, wherein the PRS configuration comprises a sparse pattern parameter K_{subc}, wherein, to calculate the non-uniform pattern, the at least one processor is configured to:
add the sparse pattern parameter K_{subc} as a subcarrier offset to a calculated sparse pattern.

10. The apparatus of claim 3, wherein the PRS configuration comprises at least one of a type of PRS pattern, a symbol offset, a slot offset, a frame index, or a periodicity, wherein, to calculate the non-uniform pattern, the at least one processor is configured to:
calculate the non-uniform pattern based on at least one of the type of PRS pattern, the symbol offset, the slot offset, the frame index, or the periodicity.

11. The apparatus of claim 10, wherein the type of PRS pattern indicates that the non-uniform pattern comprises a first pattern that is not uniform in the frequency domain, wherein the at least one processor is further configured to:
receive a second PRS configuration that indicates a set of uniform patterns in the frequency domain for a second set of PRSs;
calculate a uniform pattern of the set of uniform patterns based on the second PRS configuration, wherein the second PRS configuration indicates that the uniform pattern comprises a second pattern that is uniform in the frequency domain;
receive the second set of PRSs based on the second PRS configuration, wherein each PRS of the second set of PRSs is associated with a corresponding uniform pattern of the set of uniform patterns in the frequency domain; and
measure each PRS of the second set of PRSs based on the corresponding uniform pattern of the set of uniform patterns in the frequency domain.

12. The apparatus of claim 1, wherein, to receive the PRS configuration, the at least one processor is configured to:
receive downlink control information (DCI), a medium access control (MAC) control element (MAC-CE), or a radio resource control (RRC) configuration comprising the PRS configuration.

13. The apparatus of claim 1, wherein, to receive the PRS configuration, the at least one processor is configured to:
receive a radio resource control (RRC) configuration comprising a plurality of non-uniform patterns; and
receive downlink control information (DCI) or a medium access control (MAC) control element (MAC-CE) indicating a selection of the set of non-uniform patterns from the plurality of non-uniform patterns.

14. The apparatus of claim 1, further comprising a transceiver coupled to the at least one processor, wherein, to receive the PRS configuration and receive the set of PRSs based on the PRS configuration, the at least one processor is configured to receive the PRS configuration and receive the set of PRSs based on the PRS configuration via the transceiver.

15. An apparatus for wireless communication at a network node, comprising:
a memory; and
at least one processor coupled to the memory and, based at least in part on information stored in the memory, the at least one processor is configured to:
transmit a positioning reference signal (PRS) configuration that indicates a set of non-uniform patterns in a frequency domain for a set of PRSs; and
transmit the set of PRSs based on the PRS configuration, wherein each PRS of the set of PRSs is associated with a corresponding non-uniform pattern of the set of non-uniform patterns in the frequency domain.

16. The apparatus of claim 15, wherein the set of non-uniform patterns comprises at least one of a nested pattern or a co-prime pattern.

17. (canceled)

18. (canceled)

19. (canceled)

20. (canceled)

21. (canceled)

22. (canceled)

23. (canceled)

24. (canceled)

25. (canceled)

26. (canceled)

27. A method of wireless communication at a user equipment (UE), comprising:
receiving a positioning reference signal (PRS) configuration that indicates a set of non-uniform patterns in a frequency domain for a set of PRSs;
receiving the set of PRSs based on the PRS configuration, wherein each PRS of the set of PRSs is associated with a corresponding non-uniform pattern of the set of non-uniform patterns in the frequency domain; and
measuring each PRS of the set of PRSs based on the corresponding non-uniform pattern of the set of non-uniform patterns in the frequency domain.

28. The method of claim 27, further comprising:
calculating a non-uniform pattern of the set of non-uniform patterns based on the PRS configuration.

29. A method of wireless communication at a network node, comprising:
transmitting a positioning reference signal (PRS) configuration that indicates a set of non-uniform patterns in a frequency domain for a set of PRSs; and
transmitting the set of PRSs based on the PRS configuration, wherein each PRS of the set of PRSs is associated with a corresponding non-uniform pattern of the set of non-uniform patterns in the frequency domain.

30. The method of claim 29, wherein the PRS configuration indicates that a non-uniform pattern of the set of non-uniform patterns comprises a first pattern that is not uniform in the frequency domain; further comprising:
transmitting a second PRS configuration that indicates a set of uniform patterns in the frequency domain for a second set of PRSs and indicates that a uniform pattern of the set of uniform patterns comprises a second pattern that is uniform in the frequency domain; and
transmitting the second set of PRSs based on the second PRS configuration, wherein each PRS of the second set of PRSs is associated with a corresponding uniform pattern of the set of uniform patterns in the frequency domain.
